(19) United States
(12) Patent Application Publication
(10) Pub. No.: US 2019/0026902 A1
(43) Pub. Date: Jan. 24, 2019

(54) IMAGING APPARATUS AND CONTROL METHOD

(71) Applicant: CANON KABUSHIKI KAISHA, Tokyo (JP)

(72) Inventors: Kousuke Kiyamura, Kawasaki-shi (JP); Mitsuhiro Izumi, Yokohama-shi (JP); Takeshi Uchida, Yokohama-shi (JP)

(21) Appl. No.: 16/031,470

(22) Filed: Jul. 10, 2018

(30) Foreign Application Priority Data
Jul. 20, 2017 (JP) 2017-140851
Aug. 23, 2017 (JP) 2017-160110
Feb. 27, 2018 (JP) 2018-033447

(51) Int. Cl. G06T 7/20; H04N 19/139; H04N 5/235; G06T 7/00

(52) U.S. Cl. CPC G06T 7/20; H04N 19/139; G06T 7/97; G06T 7/0002; H04N 5/2351

(57) ABSTRACT

According to an aspect of the invention, an imaging apparatus includes: an imaging unit capable of continuously acquiring first images and second images for which a time from start of accumulation to end thereof is longer than that of the first image; a computing unit configured to calculate a motion vector from the plurality of first images; and an image processing unit configured to perform image processing on a moving image generated from the second images using the motion vector.

### BACKGROUND OF THE INVENTION

### Field of the Invention

The present invention relates to an imaging apparatus and a control method thereof, and particularly, to an imaging apparatus configured to output a plurality of images with different accumulation periods synchronized from an image element.

### Description of the Related Art

When simultaneous capturing of moving images and still images can be performed by one camera, captured scenes can be seen as moving images, a decisive scene in the moving images can be enjoyed as a still image, and it is possible to greatly increase a value of a captured image. In addition, if one camera can capture moving images at a general frame rate and moving images at a high frame rate at the same time, a viewer can enjoy specific scenes as high-quality work while switching to a slow motion image and it is possible to deliver a rich impression to the viewer. Here, generally, when there is a type of impression of choppiness with frame advance in a reproduced moving image, quality greatly deteriorates. In order to avoid an impression of choppiness, it is necessary to set an accumulation time close to one frame period in a capturing sequence. That is, when the frame rate is 30 fps, a relatively long accumulation time such as 1/30 sec or 1/60 sec is appropriate. In particular, this setting is important in a situation in which an orientation of a camera is unstable, for example, in the air.

On the other hand, in still images, since a sharpness with which a moment may be captured is required, in order to obtain a stop motion effect, it is necessary to set, for example, a short accumulation time of about 1/1,000 sec. In addition, in moving images with a high frame rate, since one frame period is short, when a frame rate is, for example, 120 fps, a short accumulation time of 1/125 sec or 1/250 sec is inevitably set. Here, in the imaging apparatus in Japanese Patent Laid-Open No. 2014-48459, a technology in which pixels of an image element include a pair of asymmetric photodiodes is disclosed. In Japanese Patent Laid-Open No. 2014-48459, one photodiode has high light receiving efficiency and the other photodiode has low light receiving efficiency. Therefore, in Japanese Patent Laid-Open No. 2014-48459, it is suggested that two images with different accumulation periods can be captured at the same time. On the other hand, in capturing of moving images, in order to reduce blur of the captured image caused by hand shake of a photographer, shake correction may be performed using a motion vector calculated by comparing and computing a past frame and a current frame. In addition, the calculated motion vector can be used for compression of moving images or subject tracking.

However, as described above, in order to secure the quality of moving images, an accumulation time of moving images is relatively long. Therefore, due to movement of the subject and the imaging apparatus during the accumulation time, blur occurs in each frame image and sharpness is lowered. Thereby, accuracy of the motion vector calculated by comparison between frames is reduced, which results in deterioration of performance of shake correction, moving image compression, and subject tracking.

### SUMMARY OF THE INVENTION

The present invention proposes an imaging apparatus that improves calculation accuracy of a motion vector according to moving image capturing while capturing still images and moving images at the same time.

According to an aspect of the invention, an imaging apparatus comprises: a memory; and a controller which operates on the basis of data stored in the memory. The controller comprises: an imaging unit capable of continuously acquiring first images and second images for which a time from start of accumulation to end thereof is longer than that of the first image; a computing unit configured to calculate a motion vector from the plurality of first images; and an image processing unit configured to perform image processing on a moving image generated from the second images using the motion vector.

Further features of the present invention will become apparent from the following description of exemplary embodiments with reference to the attached drawings.

### BRIEF DESCRIPTION OF THE DRAWINGS

FIGS. 1A and 1B show external appearance views of a digital still motion camera.

FIG. 2 is a block diagram showing an imaging apparatus in a first example of a first invention.

FIG. 3 is a circuit diagram showing a configuration example of a pixel.

FIG. 4 is a diagram for explaining an imaging condition setting screen for still images and moving images.

FIG. 5 is a program AE line diagram in a dual image mode.

FIG. 6 is a diagram showing a difference in shutter speeds between a still image and a moving image in imaging sequences.

FIG. 7 shows timing charts of drive sequences of an image element.

FIG. 8 is a diagram showing a display unit which displays a live view after power is supplied to an imaging apparatus.

FIG. 9 is a diagram showing one frame in an image acquired by manipulating switches ST and MV.

FIG. 10 is a diagram for explaining an application example of still images and moving images.

FIG. 11 is a diagram showing a configuration of a shake correction processing unit.

FIGS. 12A and 12B are diagrams for explaining a block matching method.

FIG. 13 is a diagram showing timings at which accumulation and reading in an image element occur and shake correction processing is performed.

FIG. 14 is a diagram for explaining segmentation processing of a segmentation processing unit.

FIG. 15 is a block diagram showing an imaging apparatus in a second example of the first invention.

FIG. 16 is a diagram showing a configuration of a shake correction processing unit.

FIG. 17 is a diagram showing a configuration of a shake correction processing unit in a third example of the first invention.

FIG. 18 is a flowchart showing operations of the shake correction processing unit.

FIG. 19 is a diagram showing a configuration of a shake correction processing unit in a fourth example of the first invention.

FIG. 20 is a flowchart showing operations of the shake correction processing unit.

FIG. 21 is a sequence diagram showing exposure, transfer, and reading for imaging in a second invention.

FIGS. 22A and 22B show diagrams of results of imaging for speed detection.

FIGS. 23A to 23C show diagrams of sequences of exposure and transfer in which the number of transfers is changed.

FIGS. 24A and 24B show diagrams of imaging results.

FIGS. 25A and 25B show sequence diagrams of an example in which the number of ND stages is changed.

FIGS. 26A and 26B show external appearance views of a digital still motion camera.

FIG. 27 is a block diagram showing an example of an imaging apparatus in a third invention.

FIG. 28 is a circuit diagram showing a circuit example of an image element.

FIG. 29 shows timing charts of examples of drive sequences of an image element.

FIGS. 30A to 30C show explanatory diagrams of an example of an optical flow acquisition method.

FIG. 31 shows diagrams of a captured image in a first comparative example.

FIG. 32 shows diagrams of a captured image in a second comparative example.

FIG. 33 shows diagrams of a captured image in an example.

FIG. 34 shows diagrams of images after a low pass filter is applied in an example.

FIG. 35 is a flowchart showing an optical flow estimation flow in an example.

FIG. 36 shows timing charts if exposures in an example are performed at nonuniform timings.

FIG. 37 shows diagrams of an imaging example if an exposure in an example is performed at nonuniform timings.

### DESCRIPTION OF THE EMBODIMENTS

Examples of the present invention will be described below with reference to the drawings.

### First Invention

### First Example

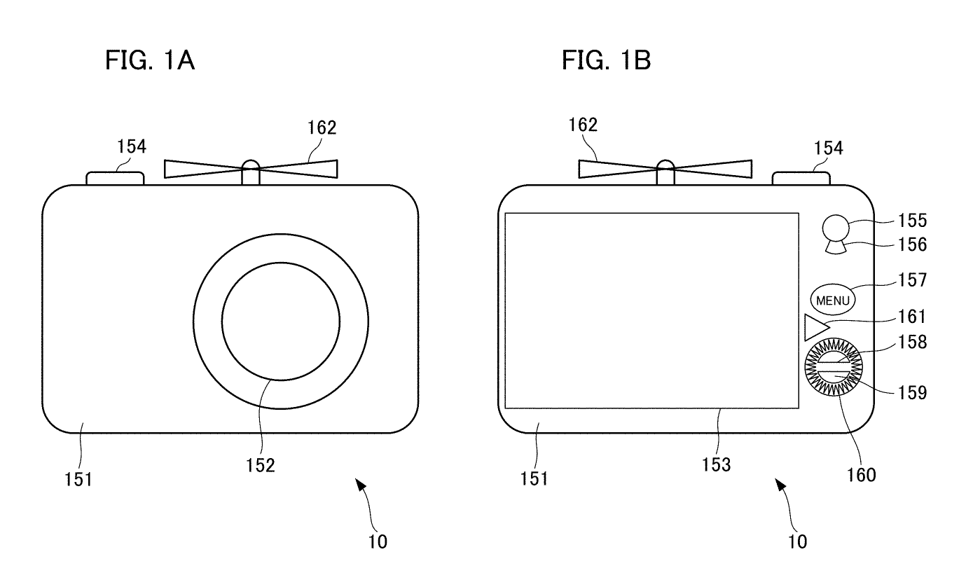

An imaging apparatus in which an imaging optical system for imaging and the like are added to an image processing device will be described below as a preferable example of the present invention. FIG. 1 shows external appearance views of a digital still motion camera as an imaging apparatus 10 according to the present example. FIG. 1A is a front view of the imaging apparatus 10, and FIG. 1B is a rear view of the imaging apparatus 10. Referring to FIG. 1, the imaging apparatus 10 according to the present example includes an imaging apparatus body 151 in which an image element and a shutter device are accommodated, an imaging optical system 152 having an aperture therein, and a movable display unit 153 configured to display imaging information and an image. In addition, a switch ST 154 that is used for mainly capturing a still image and a switch MV 155 which is a button for starting and stopping capturing of a moving image are included. The display unit 153 has a display luminance range in which an image having a wide dynamic range can be displayed without reducing the luminance range. In addition, an imaging mode selection lever 156 for selecting an imaging mode, a menu button 157 for performing transition to a function setting mode in which a function of the imaging apparatus 10 is set, and up and down switches 158 and 159 for changing various setting values are included. In addition, a dial 160 for changing various setting values and a reproduction button 161 for performing transition to a reproduction mode in which an image recorded in a recording medium which is accommodated in the imaging apparatus body 151 is reproduced on the display unit 153 are included. In addition, a propeller 162 for causing the imaging apparatus 10 to rise into the air is included in order to perform imaging in the air.

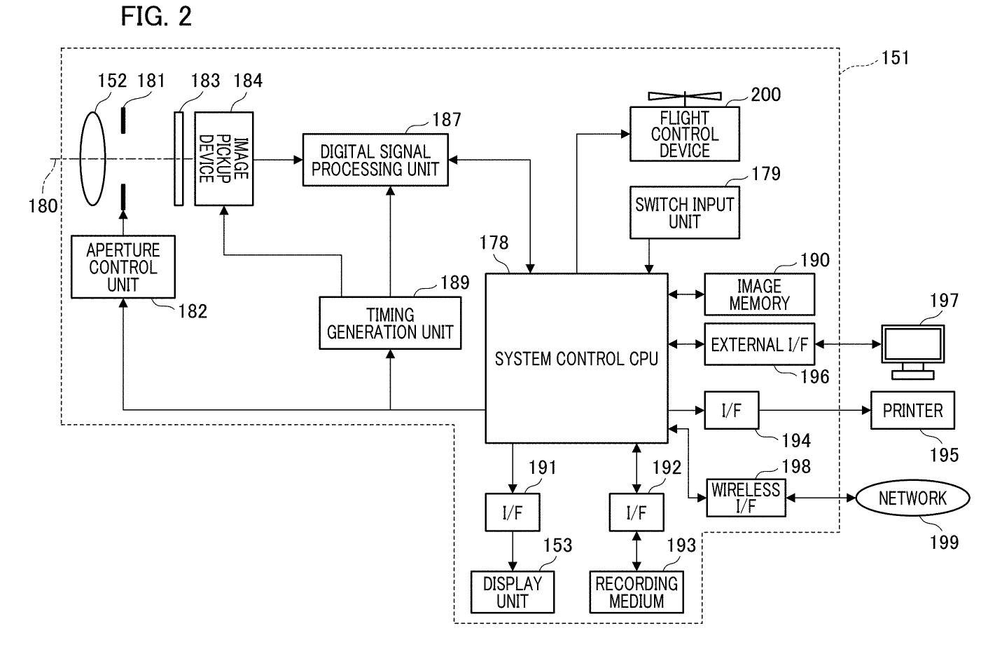

FIG. 2 is a block diagram showing a schematic configuration of the imaging apparatus 151 according to the present example. Here, a range of the imaging apparatus body 151 according to the present example is indicated by a dotted line. In FIG. 2, an image element (imaging device) 184 converts an optical image of a subject formed through the imaging optical system (optical system) 152 into an electrical image signal. The imaging optical system 152 forms the optical image of the subject on the image element 184. An optical axis 180 is an optical axis of the imaging optical system 152. An aperture 181 is an aperture for adjusting an intensity of light that passes through the imaging optical system 152 and is controlled by an aperture control unit 182. An optical filter 183 limits wavelengths of light that enters the image element 184 and a spatial frequency that is transmitted to the image element 184. The image element 184 has a sufficient number of pixels, a signal reading speed, a color gamut, and a dynamic range which satisfy ultra high definition television standards.

A digital signal processing unit 187 performs various types of correction on digital image data output from the image element 184 and then compresses the image data. A timing generation unit (control device) 189 outputs various timing signals to the image element 184 and the digital signal processing unit 187. A system control CPU (control device) 178 controls various types of computing and the entire digital still motion camera.

An image memory 190 temporarily stores image data, and a display interface unit 191 displays a captured image. The display unit 153 is a display device such as a liquid crystal display. A recording medium 193 is a removable recording medium such as a semiconductor memory for recording image data, additional data, and the like. A recording interface unit 192 is an interface for performing recording or reading in or from the recording medium 193. An external interface unit 196 is an interface for communication with an external computer 197 and the like. A printer 195 is a printer such as a small ink jet printer. A print interface unit 194 is an interface unit configured to output to and print a captured image on the printer 195. A computer network 199 is a computer network such as the Internet. A wireless interface unit 198 is an interface unit configured to perform communication via the network 199. A switch input unit 179 includes the switch ST 154, the switch MV 155, and a plurality of switches for switching between various modes. A flight control device 200 is a flight control device for performing imaging in the air.

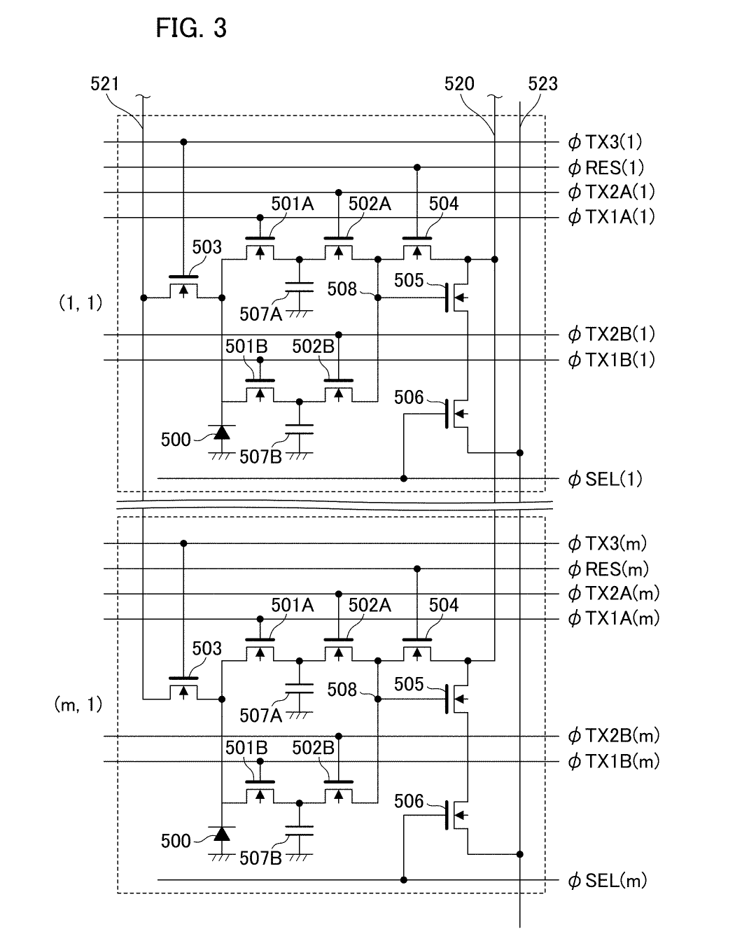

FIG. 3 is a partial circuit diagram of the image element 184. In FIG. 3, among a plurality of pixel elements of the image element 184, a pixel element of the 1^{st} row and 1^{st} column (1,1) and a pixel element of the m-th row and 1^{st} column (m,1) which is in the last line are shown. The same components of the pixel element of the 1^{st} row and 1^{st} column (1,1) and the pixel element of the m-th row and 1^{st} column (m,1) are denoted with the same reference numerals. One pixel element of the image element 184 according to the present example includes two signal holding units 507A and 507B for one photodiode 500. Since a basic structure of the image element 184 including signal holding units is disclosed in Japanese Patent Laid-Open No. 2013-172210 by the applicants, description thereof will be omitted.

In the circuit diagram of FIG. 3, one pixel element includes the photodiode 500, a first transfer transistor 501A, and the first signal holding unit 507A. In addition, one pixel element includes a second transfer transistor 502A, a third transfer transistor 501B, the second signal holding unit 507B, and a fourth transfer transistor 502B. Furthermore, one pixel element includes a fifth transfer transistor 503, a floating diffusion region 508, a reset transistor 504, an amplifying transistor 505, and a select transistor 506.

In addition, the first transfer transistor 501A is controlled by a transfer pulse φTX1A, and the second transfer transistor 502A is controlled by a transfer pulse φTX2A. In addition, the third transfer transistor 501B is controlled by a transfer pulse φTX1B, and the fourth transfer transistor 502B is controlled by a transfer pulse φTX2B. In addition, the reset transistor 504 is controlled by a reset pulse φRES, and the select transistor 506 is controlled by a select pulse φSEL. In addition, the fifth transfer transistor 503 is controlled by a transfer pulse φTX3. Here, control pulses are transmitted from a vertical scanning circuit (not shown).

In addition, in FIG. 3, a power line 520, a power line 521, and a signal output line 523 are included. Since the image element 184 constituting the imaging apparatus 10 according to the present example includes two signal holding units 507A and 507B for one photodiode 500, it is possible to capture a still image which is a first image and a moving image which is a second image at the same time. Therefore, it is possible to read two images with different accumulation periods without reducing S/N.

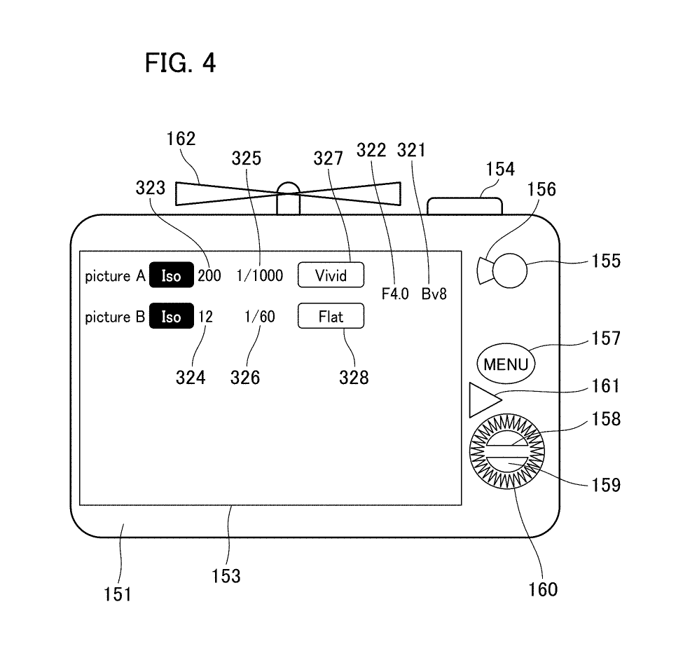

FIG. 4 is a diagram for explaining an imaging condition setting screen for a still image (picture A) and a moving image (picture B) in the imaging apparatus body 151. When the imaging mode selection lever 156 is rotated in a clockwise direction, the mode is switched to a dual image mode in which two images can be captured at the same time. On the display unit 153, a Bv value 321 corresponding to the luminance of a subject at that time, an F number 322, and ISO sensitivities 323 and 324 and shutter speeds 325 and 326 of a still image (picture A) and a moving image (picture B) are displayed. In addition, picture modes 327 and 328 currently set for the still image (picture A) and the moving image (picture B) are displayed. The picture mode can be selected from among a plurality of choices according to the purpose of imaging using the up and down switches 158 and 159 and the dial 160.

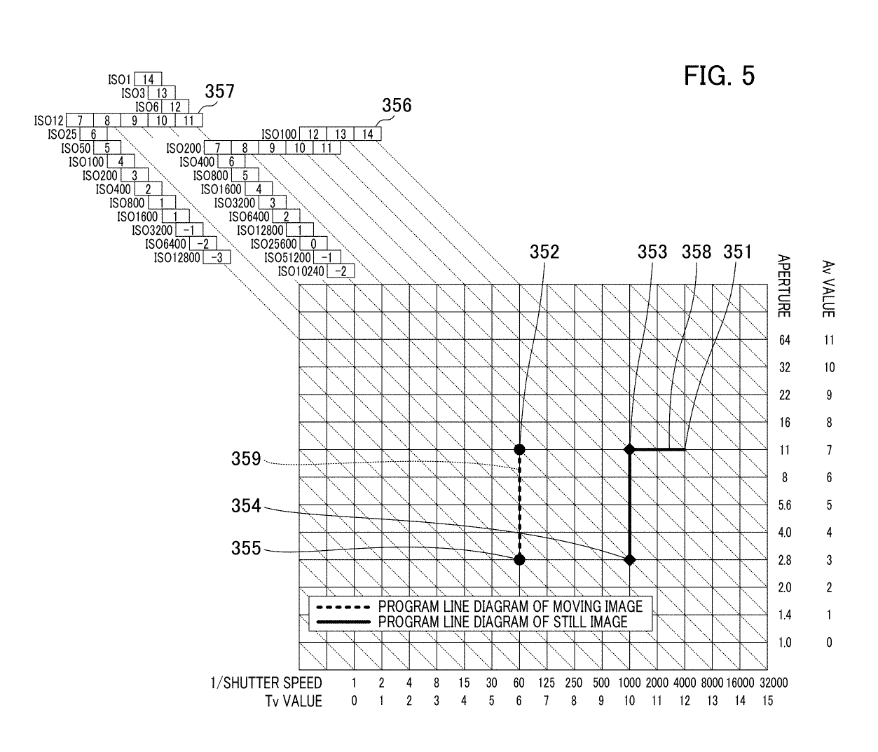

FIG. 5 is a program automatic exposure (AE) line diagram in a dual image mode according to the present example. The horizontal axis represents a Tv value and a shutter speed corresponding thereto, and the vertical axis represents an Av value and an aperture value corresponding thereto, and equal-Bv lines are in an oblique direction. A gain notation region 356 shows a relationship between a Bv value and an ISO sensitivity of a still image (picture A). A gain notation region 357 shows a relationship between a Bv value and an ISO sensitivity of a moving image (picture B). Variation of a shutter speed, an aperture value, and an ISO sensitivity as the luminance changes from high to low will be described. Since an imaging device according to the present example captures a still image which is a first image and a moving image which is a second image at the same time, a program AE line diagram is set to have the same aperture value for the same subject luminance.

First, when the luminance Bv is 14, in a still image, an ISO sensitivity is set to an ISO of 100. An equal-Bv line in the still image intersects a line 358 of the program line diagram of the still image and a point 351, and a shutter speed of 1/4,000 sec and an aperture value F of 11 are determined from the point 351. On the other hand, in a moving image, an ISO sensitivity is set to an ISO of 1. An equal-Bv line in the moving image (picture B) intersects a line 359 of the program line diagram of the moving image and a point 352, and a shutter speed of 1/60 sec and an aperture value F of 11 are determined from the point 352.

When the luminance Bv is 11, in a still image, an ISO sensitivity is increased by one step and set to an ISO of 200. An equal-Bv line in the still image intersects a line 358 of the program line diagram of the still image and a point 353, and a shutter speed of 1/1,000 sec and an aperture value F of 11 are determined from the point 353. On the other hand, in a moving image, an ISO sensitivity is set to an ISO of 12. An equal-Bv line in the moving image intersects a line 359 of the program line diagram of the moving image and a point 352, and a shutter speed of 1/60 sec and an aperture value F of 11 are determined from the point 352.

When the luminance Bv is 7, in a still image, an ISO sensitivity is set to an ISO of 200. An equal-Bv line in the still image intersects a line 358 of the program line diagram of the still image and a point 354, and a shutter speed of 1/1,000 sec and an aperture value F of 2.8 are determined from the point 354. On the other hand, in a moving image, an ISO sensitivity is set to an ISO of 12. An equal-Bv line in the moving image intersects a line 359 of the program line diagram of the moving image and a point 355, and a shutter speed of 1/60 sec and an aperture value F of 2.8 are determined from the point 355.

When the luminance Bv is 6, in a still image, an ISO sensitivity is increased by one step and set to an ISO of 400. An equal-Bv line in the still image intersects a line 358 of the program line diagram of the still image and a point 354, and a shutter speed of 1/1,000 sec and an aperture value F of 2.8 are determined from the point 354. On the other hand, in a moving image, an ISO sensitivity is set to an ISO of 25. An equal-Bv line in the moving image intersects a line 359 of the program line diagram of the moving image and a point 355, and a shutter speed of 1/60 sec and an aperture value F of 2.8 are determined from the point 355. Thereafter, as the luminance decreases, the still image and the moving image both have a higher gain and a higher ISO sensitivity without change in the shutter speed and the aperture value.

When an exposure operation shown in the program AE line diagram is performed, a still image in the indicated entire luminance range maintains a shutter speed of 1/1,000 sec or more and a moving image maintains a shutter speed of 1/60 sec in the entire luminance range. Therefore, it is possible to obtain a high-quality moving image with no impression of choppiness with frame advance in the moving image while a stop motion effect is obtained in the still image.

Incidentally, a still image and a moving image which are captured at the same time with the same aperture value are controlled so that ISOs are different from each other. However, when exposure control is performed so that the still image is appropriately exposed, the moving image may become saturated and ISO control may not be able to be performed. Here, in the imaging apparatus according to the present example, a short accumulation is added Np (Np>1) times at uniform time intervals at a shutter speed of 1/60 sec corresponding to a frame rate of a moving image to generate a moving image so that the ISO is substantially lowered.

In the present example, a shutter speed of 1/60 sec for a moving image is set as an accumulation period, and a shutter speed of 1/1,000 sec for a still image is set as an accumulation time, and the accumulation time for the moving image is controlled such that it is the same accumulation time as that of the still image. That is, the total accumulation time of the moving image generated by adding a short accumulation Np (Np>1) times to the signal holding unit 507 of the image element 184 is the same accumulation time as that of the still image, and control is performed with the same ISO as that for the still image captured in the same imaging period. For example, when the luminance Bv is 7, if a moving image is generated by performing accumulation and addition 16 times in a divided manner during a period at a shutter speed of 1/60 sec, one accumulation time for generating a moving image is set to 1/16,000 sec in order to perform the same ISO control as in the still image with an ISO of 200.

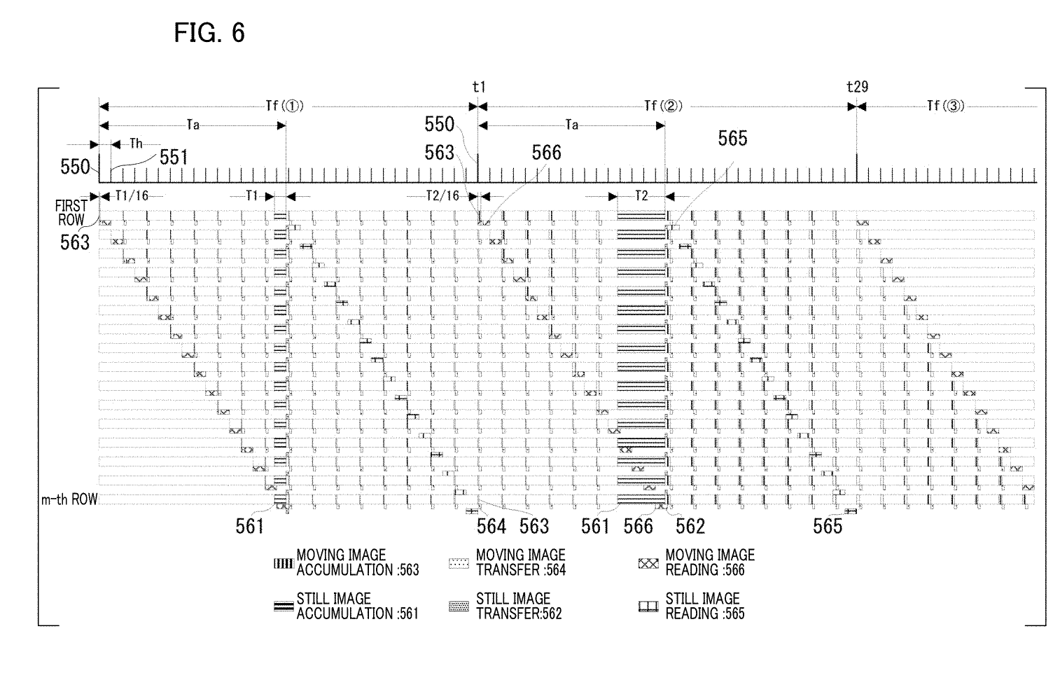

FIG. 6 is a diagram for explaining accumulation and read timings in the image element 184 in order to capture a still image which is a first image and a moving image which is a second image at the same time with the imaging apparatus according to the present example. Here, the accumulation is performed by transferring a charge generated in the photodiode 500 to the signal holding unit 507. In addition, the reading refers to outputting a charge held in the signal holding unit 507 to the outside of the image element 184 through the floating diffusion region 508.

In FIG. 6, in the imaging apparatus according to the present example, a still image and a moving image are read during one period for a vertical synchronization signal 550. In addition, while timings in 16 rows are shown in FIG. 6 for convenience, the actual image element 184 has several thousands of rows. In the present example, the final row is set to an m-th row. In addition, a still image which is a first image is generated by one accumulation (561) in all rows at the same time during one period (time Tf) for the vertical synchronization signal 550, and a moving image which is a second image is generated by adding an accumulation (563) divided among Np (Np>1) times in all rows to the signal holding unit. In the present example, the number of times of accumulation performed during one period for a moving image which is a second image is 16, and accumulation and addition are performed at uniform time intervals during one period. An interval Tf of the vertical synchronization signal 550 corresponds to a frame rate of the moving image, and is 1/60 sec in the present example.

As a result, a moving image and a still image can be captured at the same time. As the still image, an image with no blur for a short accumulation time intended by a photographer can be acquired. On the other hand, as the moving image, a smooth image with no impression of choppiness can be acquired. In an imaging period 1 in the explanatory diagram of accumulation and read timings in FIG. 6, an accumulation time (561) of still images is set to a shutter speed T1 set by a photographer. In the present example, T1= 1/2,000 sec. An accumulation end time of still images is fixed in all rows (a time of Ta from the vertical synchronization signal 550) and is set such that accumulation ends immediately before reading (565) of still images in the first row starts. Since the accumulation end time of still images is fixed in all rows, according to the shutter speed T1 for still images, an accumulation start time of still images is set for the vertical synchronization signal 550. Here, an accumulation end time Ta of still images is set to be half of the interval Tf of the vertical synchronization signal 550 or shorter.

On the other hand, accumulation of moving images is performed at uniform time intervals during one period, until immediately before reading of moving images in rows (566) starts, and in the present example, time intervals are set so that accumulation divided among 16 times ends. In this case, a time interval for accumulation of moving images is set to an integer multiple of an interval Th of a horizontal synchronization signal 551. As a result, accumulation timings of moving images in rows are the same. In FIG. 6, for convenience, a time interval for accumulating moving images is set to be twice that of a horizontal synchronization signal interval Th. Generally, a time interval for accumulating moving images is set to a value obtained by multiplying an integer that does not exceed m/Np by the interval Th of the horizontal synchronization signal 551 when the number of rows in the image element 184 is m and the number of times of accumulation of moving images during one period is Np. In addition, one accumulation time of moving images is set to T1/16 (= 1/32,000 sec). Here, an accumulation start time of moving images in rows is fixed for the vertical synchronization signal 550, and one accumulation end time of moving images is set for the vertical synchronization signal 550 according to the shutter speed T1 for still images set by a photographer.

On the other hand, an example in which a photographer sets a shutter speed T2 for still images to be longer (for example, T2= 1/500 sec) when the subject luminance is low in a part of an imaging period 2 is shown in the explanatory diagram of accumulation and read timings in FIG. 6. As described in the imaging period 1, an accumulation end time for still images is fixed in all rows (a time of Ta from the vertical synchronization signal 550) and is set such that accumulation ends immediately before reading (565) of still images in the first row starts. Since an accumulation end time of still images is fixed in all rows, according to the shutter speed T1 of still images, an accumulation start time of still images is set for the vertical synchronization signal 550.

As in the imaging period 1, accumulation of moving images is performed at uniform time intervals during one period, until immediately before reading of moving images in rows (566) starts, and time intervals are set so that accumulation divided among 16 times ends. In this case, a time interval for accumulation of moving images is set to an integer multiple of an interval Th of the horizontal synchronization signal 551. As a result, accumulation timings of moving images in rows are the same. In addition, one accumulation time of moving images is set to T2/16 (= 1/8,000 sec). Here, an accumulation start time of moving images in rows is fixed for the vertical synchronization signal 550, and one accumulation end time of moving images is set for the vertical synchronization signal 550 according to the shutter speed T2 for still images set by a photographer. In the imaging period 2 in the explanatory diagram of accumulation and read timings in FIG. 6, since an accumulation time T2 of still images is long, the number of times Np of accumulation of moving images during one period is 14. Therefore, moving images generated in the imaging period 2 are corrected using still images generated in the imaging period 2.

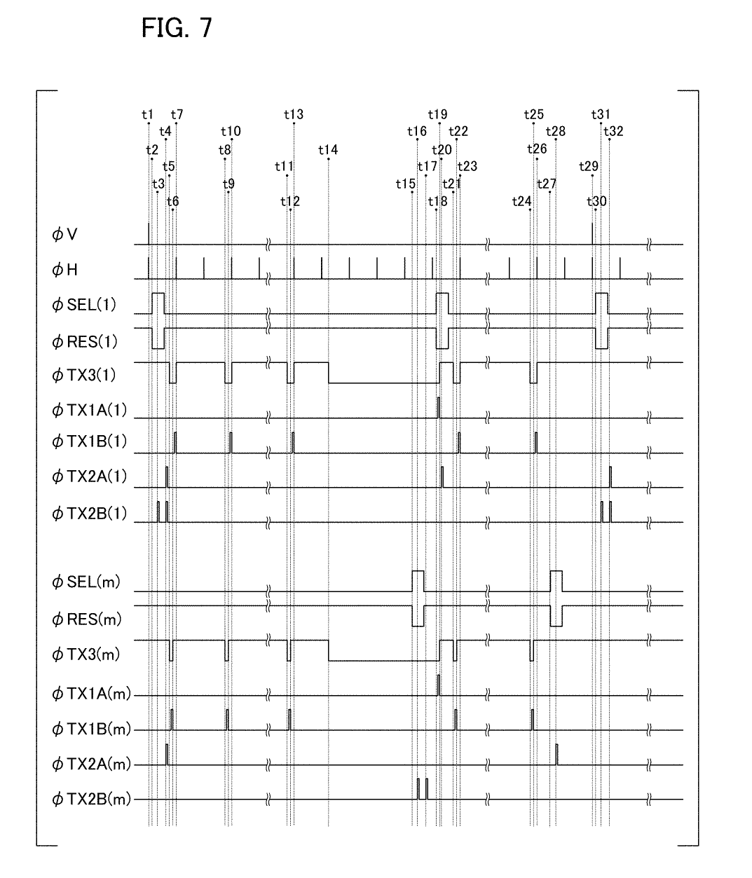

Next, a method of controlling the image element 184 that can capture a still image which is a first image and a moving image which is a second image in the imaging period 2 in the explanatory diagram of accumulation and read timings in FIG. 6 will be described using timing charts in FIG. 7. In the timing charts in FIG. 7, a rising time t1 of a vertical synchronization signal φV is the same as a time 1 of the vertical synchronization signal 550 at which the imaging period 2 in the explanatory diagram of accumulation and read timings in FIG. 6 starts.

In the image element 184 according to the present example, there are m rows of pixel columns in the vertical direction. In FIG. 7, timings of the first row and the m-th and last row are shown. First, at the time t1, in the timing generation unit 189, the vertical synchronization signal φV reaches a high level and at the same time, a horizontal synchronization signal φH reaches a high level. At a time t2 synchronized with the vertical synchronization signal φV that reaches a high level, when a reset pulse φRES(1) in the first row reaches a low level, the reset transistor 504 in the first row is turned off, and a reset state of the floating diffusion region 508 is released. At the same time, when a select pulse φSEL(1) in the first row reaches a high level, the select transistor 506 in the first row is turned on, and an image signal in the first row can be read.

At a time t3, when a transfer pulse φTX2B(1) in the first row reaches a high level, the fourth transfer transistor 502B in the first row is turned on. Then, a signal charge of moving images added and accumulated in the signal holding unit 507B during an immediately preceding imaging period (the imaging period 1 in FIG. 6) is transferred to the floating diffusion region 508. In addition, an output corresponding to a change in potential of the floating diffusion region 508 is read out to the signal output line 523 through the amplifying transistor 505 and the select transistor 506. Then, the result is supplied to a readout circuit (not shown) and is output to the outside as a moving image signal in the first row (shown in moving image reading (566) in FIG. 6).

At a time t4, a transfer pulse φTX2B(1) in the first row and transfer pulses φTX2A in all rows (in FIG. 7, φTX2A(1) and φTX2A(m)) become a high level. Then, the fourth transfer transistor 502B in the first row and the second transfer transistors 502A in all rows are turned on. In this case, reset pulses φRES in all rows have already become a high level and the reset transistor 504 is turned on. Therefore, the floating diffusion regions 508 in all rows, the signal holding units 507A for still images in all rows, and the signal holding unit 507B for moving images in the first row are reset. In addition, at the time t4, the select pulse φSEL(1) in the first row reaches a low level.

At a time t5, when transfer pulses φTX3 in all rows become a low level, the fifth transfer transistors 503 in all rows are turned off. Then, resetting of the photodiodes 500 in all rows is released, and accumulation of signal charges of moving images in the photodiodes 500 in all rows starts (shown in accumulation (563) in FIG. 6). Here, a time interval Tb between the time t1 at which the vertical synchronization signal φV reaches a high level and the time t5 at which accumulation of signal charges of moving images in the photodiodes 500 in all rows starts is fixed.

Incidentally, start of accumulation of moving images in the first row at the time t5 in the timing charts in FIG. 7 is start of accumulation of moving images in the imaging period 2 shown in FIG. 6. Start of accumulation of moving images in the m-th row at the time t5 is start of accumulation of moving images in the imaging period 1 in FIG. 6. In FIG. 6 of the present example, accumulation times of still images and moving images in the imaging period 1 and the imaging period 2 are different from each other. Since the accumulation time in the imaging period 1 is shorter than the accumulation time in the imaging period 2, accumulation of moving images in the m-th row in the imaging period 1 ends earlier.

Immediately before a time t6, when a transfer pulse φTX1B(m) in the m-th row reaches a high level, the third transfer transistor 501B in the m-th row is turned on. Then, a signal charge accumulated in the photodiode 500 in the m-th row is transferred to the signal holding unit 507B that maintains charges of moving images in the m-th row (shown in moving image transfer (564) in FIG. 6). In addition, at the time t6, when the transfer pulse φTX1B(m) in the m-th row reaches a low level, the third transfer transistor 501B in the m-th row is turned off, and transfer of the signal charge accumulated in the photodiode 500 to the signal holding unit 507B ends.

Here, the time t5 to the time t6 corresponds to one accumulation time (=T1/16) for moving images in the imaging period 1 in FIG. 6. In addition, at the time t6, the transfer pulse φTX3(m) in the m-th row reaches a high level, and the fifth transfer transistor 503 in the m-th row is turned on, and the photodiode 500 in the m-th row is reset.

Immediately before a time t7, when the transfer pulse φTX1B(1) in the first row reaches a high level, the third transfer transistor 501B in the first row is turned on. Then, a signal charge accumulated in the photodiode 500 in the first row is transferred to the signal holding unit 507B that maintains charges of moving images in the first row. In addition, at the time t7, when the transfer pulse φTX1B(1) in the first row reaches a low level, the third transfer transistor 501B in the first row is turned off, and transfer of the signal charge accumulated in the photodiode 500 in the first row to the signal holding unit 507B in the first row ends. Here, the time t5 to the time t7 corresponds to one accumulation time (=T2/16) for moving images in the imaging period 2 in FIG. 6. In addition, at the time t7, the transfer pulse φTX3(1) in the first row reaches a high level, the fifth transfer transistor 503 in the first row is turned on, and the photodiode 500 in the first row is reset.

At a time t8 twice as long as a horizontal synchronization signal interval Th from the time t5 at which accumulation of the 1st moving image starts in the imaging period which starts at the time t1, accumulation of the 2nd moving image starts. Since an accumulation operation of the 2nd moving image which starts at the time t8 and ends at a time t10 is the same as an accumulation operation of the 1st moving image which starts at the time t5 and ends at the time t7, description thereof will be omitted.

Here, in accumulation operations of the 1^{st} and 2nd moving images, a signal charge of moving images in two accumulation periods is added to and held in the signal holding unit 507B. In addition, accumulation of the 6th moving image starts at a time t11. Then, the time t11 at which accumulation of the 6th moving image starts is set to a time of T=6×2×Th+Tb from the time t1 at which the vertical synchronization signal φV reaches a high level. Here, Th is a time interval of the horizontal synchronization signal φH, and Tb is a time interval between the time t1 at which the vertical synchronization signal φV reaches a high level and the time t5 at which accumulation of signal charges of the 1st moving image in the photodiode 500 starts. Since an accumulation operation of the 6th moving image which starts at the time t11 and ends at a time t13 is the same as an accumulation operation of the 1st moving image which starts at the time t5 and ends at the time t7, description thereof will be omitted.

Next, accumulation of a still image which is a first image is performed at a time t14. In the present example, the number of times of accumulation of still images during one imaging period is 1. Since a time at which reading of a still image (shown in still image reading (565) in FIG. 6) for the vertical synchronization signal φV starts is fixed, an accumulation end time (the time Ta in FIG. 6) of still images for the vertical synchronization signal φV is fixed, and accumulation of still images is set to end at a time t19. When a shutter speed T2 for still images is set by a photographer, in the imaging apparatus according to the present example, an accumulation start time of still images is controlled.

At the time t14 which is a time T2 earlier than the time t19 at which accumulation of still images ends, when transfer pulses φTX3 in all rows become a low level, the fifth transfer transistors 503 in all rows are turned off. Then, resetting of the photodiodes 500 in all rows is released, and accumulation of signal charges of still images in the photodiodes 500 in all rows starts (shown in still image accumulation (561) in FIG. 6).

In addition, during accumulation of signal charges of still images, reading of moving images in the m-th row in the imaging period 1 ends. First, at a time t15, when the reset pulse φRES(m) in the m-th row reaches a low level, the reset transistor 504 in the m-th row is turned off, and a reset state of the floating diffusion region 508 is released. At the same time, when the select pulse φSEL(m) in the m-th row reaches a high level, the select transistor 506 in the m-th row is turned on, and an image signal in the m-th row can be read.

At a time t16, when the transfer pulse φTX2B(m) in the m-th row reaches a high level, the fourth transfer transistor 502B in the m-th row is turned on. Then, a signal charge of moving images added and accumulated in the signal holding unit 507B during an immediately preceding imaging period (the imaging period 1 in FIG. 6) is transferred to the floating diffusion region 508. In addition, an output corresponding to a change in potential of the floating diffusion region 508 is read out to the signal output line 523 through the amplifying transistor 505 and the select transistor 506. Then, the result is supplied to a readout circuit (not shown) and is output to the outside as a moving image signal in the m-th row (shown in moving image reading (566) in FIG. 6). In this case, reading of moving images as second images in the imaging period 1 is completed and next, reading of still images as first images in the imaging period 2 is performed (shown in moving image reading (566) in FIG. 6).

At a time t17, when the transfer pulse φTX2B(m) in the m-th row reaches a high level, the fourth transfer transistor 502B in the m-th row is turned on. In this case, since the reset pulse φRES(m) in the m-th row has already became a high level and the reset transistor 504 is turned on, the floating diffusion region 508 in the m-th row and the signal holding unit 507B for moving images in the m-th row are reset. In addition, at a time t17, the select pulse φSEL(m) in the m-th row reaches a low level.

At a time t18, when the reset pulse φRES(1) in the first row reaches a low level, the reset transistor 504 in the first row is turned off, and a reset state of the floating diffusion region 508 is released. At the same time, when the select pulse φSEL(1) in the first row reaches a high level, the select transistor 506 in the first row is turned on, and an image signal in the first row can be read.

Immediately before the time t19, when the transfer pulses φTX1A in all rows become a high level, the first transfer transistors 501A in all rows are turned on. Then, a signal charge accumulated in the photodiodes 500 in all rows is transferred to the signal holding unit 507A that maintains charges of still images in all rows (shown in still image transfer (562) in FIG. 6). In addition, at the time t19, when the transfer pulses φTX1A in all rows become a low level, the first transfer transistors 501A in all rows are turned off, and transfer of a signal charge accumulated in the photodiodes 500 in all rows to the signal holding unit 507A ends. Here, the time t14 to the time t19 corresponds to the accumulation time T2 of still images in the imaging period 2 in FIG. 6.

At a time t20, when the transfer pulse φTX2A(1) in the first row reaches a high level, the second transfer transistor 502A in the first row is turned on, and a signal charge of still images accumulated in the signal holding unit 507A in the first row is transferred to the floating diffusion region 508. In addition, an output corresponding to a change in potential of the floating diffusion region 508 is read out to the signal output line 523 through the amplifying transistor 505 and the select transistor 506 in the first row. Then, the result is supplied to a readout circuit (not shown) and is output to the outside as a still image signal in the first row (shown in still image reading (565) in FIG. 6).

In addition, accumulation of the 7th moving image starts at the time t21. Here, the time t21 at which accumulation of the 7th moving image starts is set to a time of T=(7+2)×2×Th+Tb from the time t1 at which the vertical synchronization signal φV reaches a high level. In the present example, since an accumulation period of two moving images overlaps an accumulation period of still images (shown in still image accumulation (561) in FIG. 6), the time t21 at which accumulation of the 7th moving image starts is the same as the 9th accumulation start time of the imaging period 1.

Since an accumulation operation of the 7th moving image which starts at the time t21 and ends at a time t23 is the same as an accumulation operation of the 1st moving image which starts at the time t5 and ends at the time t7, description thereof will be omitted. In addition, accumulation of the final 14th moving image of the imaging period 2 starts at a time t24. Here, the time t24 at which accumulation of the 14th moving image starts is set to a time of T=(14+2)×2×Th+Tb from the time t1 at which the vertical synchronization signal φV reaches a high level. Since an accumulation operation of the 14th moving image which starts at the time t24 and ends at a time t26 is the same as an accumulation operation of the 1st moving image which starts at the time t5 and ends at the time t7, description thereof will be omitted.

At a time t27, when the reset pulse φRES(m) in the m-th row reaches a low level, the reset transistor 504 in the m-th row is turned off and a reset state of the floating diffusion region 508 is released. At the same time, when the select pulse φSEL(m) in the m-th row reaches a high level, the select transistor 506 in the m-th row is turned on and an image signal in the m-th row can be read.

At a time t28, when the transfer pulse φTX2A(m) in the m-th row reaches a high level, the second transfer transistor 502A in the m-th row is turned on, and a signal charge of still images accumulated in the signal holding unit 507A in the m-th row is transferred to the floating diffusion region 508. In addition, an output corresponding to a change in potential of the floating diffusion region 508 is read out to the signal output line 523 through the amplifying transistor 505 and the select transistor 506 in the m-th row. Then, the result is supplied to a readout circuit (not shown) and is output to the outside as a still image signal in the m-th row (shown in still image reading (565) in FIG. 6).

At a time t29, in the timing generation unit 189, the vertical synchronization signal φV reaches a high level and an imaging period 3 starts. As described above, in the imaging apparatus according to the present example, an accumulation end time of still images is fixed for a vertical synchronization signal, and an accumulation start time of accumulation of moving images performed a plurality of times during one imaging period is fixed for the vertical synchronization signal. Thereby, moving images and still images can be read in the same imaging period.

In addition, the imaging apparatus according to the present example can continuously acquire a still image which is a first image and a moving image which is a second image for which a time from start of accumulation to end thereof is longer than that of the first image. Here, the time from start of accumulation to end thereof represents an accumulation time in a plurality of still images which are a plurality of first images and an accumulation period in a moving image which is a second image. As a result, even though a shutter speed for still images is changed by a photographer, it is possible to capture a still image with no blur with a short accumulation time and a moving image with no impression of choppiness at the same time during one imaging period. That is, still images and moving images can be captured at the same time with high quality.

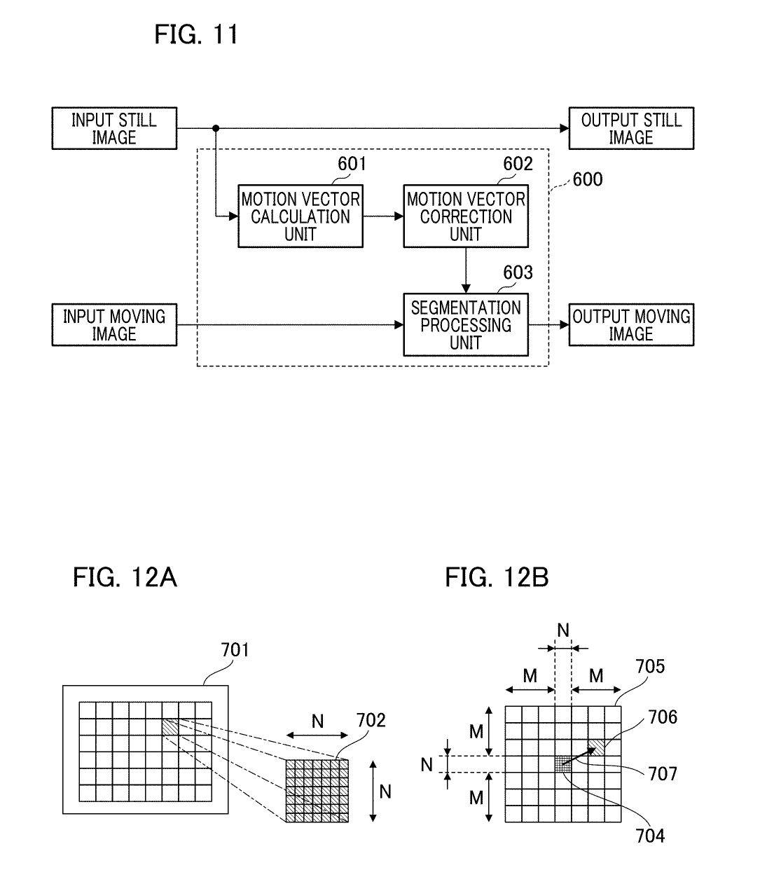

Here, shake correction processing according to the present example will be described. FIG. 11 is a diagram showing a configuration of a shake correction processing unit 600 according to the present example. The shake correction processing unit 600 is provided in the digital signal processing unit 187, performs shake correction processing on moving images based on an output of still images of the image element 184, and outputs shake-corrected moving images.

A motion vector calculation unit (computing device) 601 computes a correlation between a past frame and a current frame for a still image within the output of the image element 184 and outputs a motion vector. The past frame is an image obtained in still image reading (565) in the imaging period 1 in FIG. 6 and the current frame is an image obtained in still image reading (565) in the imaging period 2 in FIG. 6. That is, in the present example, a motion vector is calculated from a still image which is a first image. A motion vector correction unit (computing device) 602 performs the following corrections ((1) resolution, (2) frame interval, (3) accumulation timing) on the motion vector calculated from the still image according to a moving image and outputs it as a corrected motion vector.

### (1) Resolution

In order for a moving image to support a specified format such as 4K, the resolution may be adjusted by thinning the output of the image element 184. If a resolution of a still image and a resolution of a moving image are different from each other, the motion vector correction unit 602 enlarges and reduces the motion vector according to a ratio between the resolutions.

### (2) Frame Interval

A frame interval of a moving image is constant at Tf. On the other hand, in a still image, when an interval between the center of an exposure time for the past frame and the center of an exposure time for the current frame is set as a frame interval, the frame interval is not constant.

A segmentation processing unit (image processing device) 603 performs segmentation processing on the output of the moving image of the image element 184 using the calculated corrected motion vector. The segmentation processing is processing of outputting only pixels in a certain specified area from all pixels of the image element 184.

As a method of calculating a motion vector, a block matching method is used. Here, FIG. 12 shows diagrams explaining a block matching method. As shown in FIG. 12A, a plurality of reference blocks 702 with N×N pixels are arranged in a current frame 701. For an arbitrary reference block 703 (not shown), a block 704 inside a past frame 705 shown in FIG. 12B is set, and the search range 705 with (N+2M)×(N+2M) pixels is set around the block 704. In the present example, M is higher than N. A correlation of pixels between the reference block 703 and N×N blocks in the search range 705 is computed, and a position of a block 706 with the highest correlation is set as the motion vector 707.

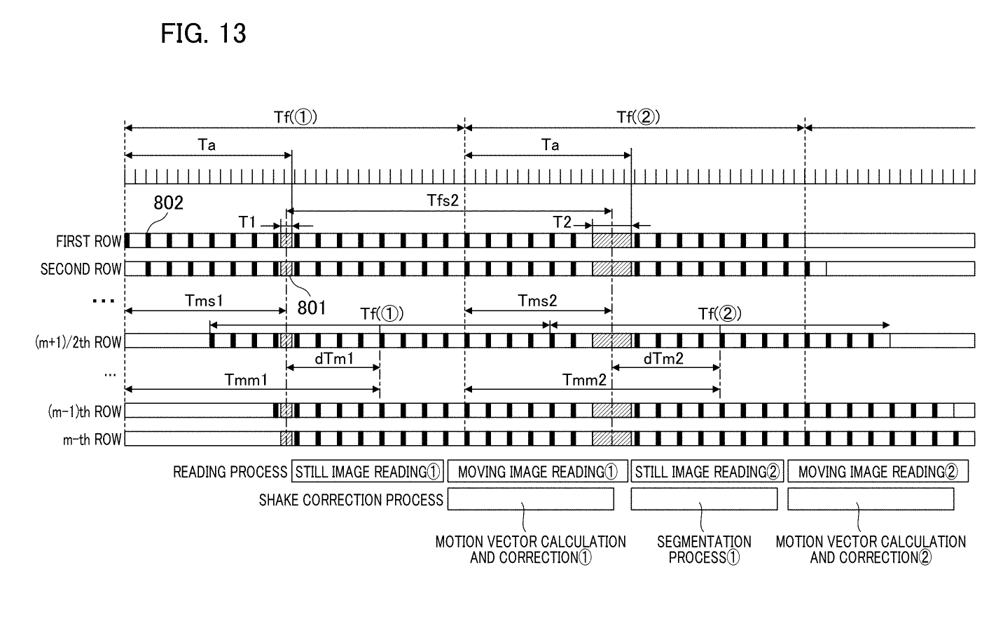

FIG. 13 is a diagram for explaining timings of accumulation and reading in the image element 184 as in FIG. 6 and shake correction processing of the shake correction processing unit 600. An area 801 indicates accumulation of still images and an area 802 indicates accumulation of moving images. For example, a frame interval Tfs2 of a still image between the imaging period 1 and the imaging period 2 is represented as follows.

Tfs2=Tf−(T2−T1)/2

Accordingly, if shutter speeds for a still image are different between the past frame and the current frame, frame intervals of the still image and the moving image are different from each other. Since the motion vector indicates an amount of movement of the image between frames, if the frame intervals are different from each other, correction is necessary. If the frame interval of the still image is different from the frame interval of the moving image, the motion vector correction unit 602 corrects a motion vector according to the ratio. When the motion vector calculated from the still image obtained in the imaging period 2 is set as As2, a motion vector AS2′ obtained by correcting the frame interval is calculated as follows.

AS2′=As2*Tf/Tfs2

Ts2=Tf−(T2−T1)/2

In addition, the motion vector correction unit 602 corrects (3) an accumulation timing and outputs a corrected motion vector.

### (3) Accumulation Timing

In the present example, since accumulation sequences differ between the moving image and the still image, timings at which the center of the image is accumulated are different. In a certain imaging period, a time from start of accumulation of the moving image to the center of an accumulation period of the (m+1)/2th row which is the center of the image is set as an accumulation timing Tm. An accumulation timing Tms1 in the still image and an accumulation timing Tmm1 in the moving image in the imaging period 1 can be shown as in FIG. 13 and are represented by the following formulae.

Tms1=Ta−T1/2

Tmm1=Th*(m+1)/2+Tf/2

In addition, a deviation dTm1 of accumulation timings of the still image and moving image in the imaging period 1 is represented by the following formula.

dTm1=Tmm1−Tms1

Similarly, an accumulation timing Tms2 of the still image, an accumulation timing Tmm2 of the moving image and a deviation dTm2 of the accumulation timings of the still image and the moving image in the imaging period 2 are represented by the following formulae.

Tms2=Ta−T2/2

Tmm2=Tmm1

dTm2=Tmm2−Tms2

Since the accumulation timing of the still image from which a motion vector is calculated and the accumulation timing of the moving image to be corrected are different from each other, it is necessary to correct the motion vector. If the accumulation timings of the still image and the moving image are different from each other, the motion vector correction unit 602 corrects the motion vector according to an amount of deviation. When motion vectors calculated from still images obtained in the imaging period 1 and the imaging period 2 are set as AS1 and AS2, a motion vector AS2″ obtained by correcting the accumulation timing is calculated as follows using linear interpolation.

AS2″=(As2−As1)/Tfs2*dTm2

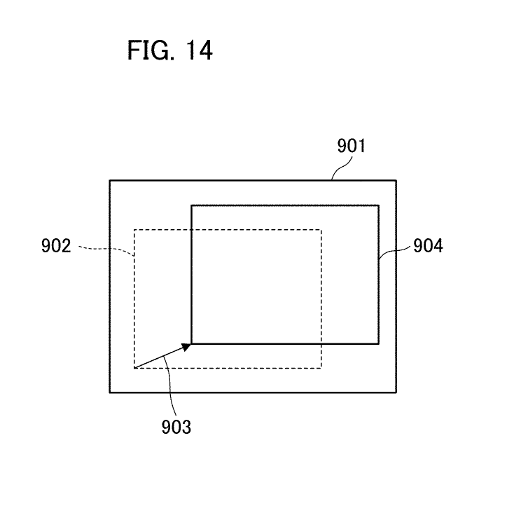

FIG. 14 is a diagram for explaining segmentation processing of the segmentation processing unit 603. With respect to an image 901 formed of all pixels acquired in the image element 184, only pixels of an area 902 are output in the past frame. In the current frame, pixels of an area 904 obtained by shifting the area 902 by a corrected motion vector 903 are output. The corrected motion vector 903 is obtained by correcting the motion vector output from the motion vector calculation unit 601 by the motion vector correction unit 602 according to the moving image.

In addition, at least one correction among three corrections of the above resolution, frame interval, and accumulation timing is performed as correction according to the moving image. Therefore, it is possible to improve calculation accuracy of the motion vector. In addition, it is desirable to perform the above three corrections. In this case, the motion vector can be corrected to correspond to the moving image and it is possible to improve calculation accuracy of the motion vector. According to segmentation processing, it is possible to shift a segmentation position of the moving image according to shake calculated as the motion vector and it is possible to reduce blurring in a captured image caused by hand shake of a photographer.

As described above, the imaging apparatus according to the present example can acquire a still image which is a first image and a moving image which is a second image with a time from start of accumulation to end thereof which is longer than that of the first image. In addition, the shake correction processing unit 600 performs shake correction processing which is image processing on the moving image generated from the moving image which is a second image using the motion vector calculated from a plurality of still images which are a plurality of first images.

As described above, in the imaging apparatus of the present invention, a time from start of accumulation to end thereof is shorter for the still image than for the moving image. Therefore, in the still image, image deterioration due to a movement of a subject and a movement of a camera resulting from hand shake is lowered and an image with high sharpness is obtained. Accordingly, compared to a case in which a correlation between frames for the moving image is computed, in a case in which a correlation between frames for the still image is computed, it is possible to improve computing accuracy and it is possible to improve calculation accuracy of the motion vector.

As shown in FIG. 13, in the imaging period 1, reading of the still image ends before reading of the moving image ends. In addition, before reading of the moving image ends, the motion vector calculation unit 601 starts calculation of the motion vector. This is the same as in other imaging periods. That is, in the imaging apparatus of the present example, before the image element 184 ends reading of the moving image which is a second image, reading of the still image which is a first image ends, and the motion vector calculation unit 601 which is a computing device starts calculation of the motion vector.

In the related art, calculation of the motion vector is started after reading of the moving image ends. However, in the present example, a start timing of the motion vector becomes earlier and processing can be performed at a higher speed. If the number of pixels of the still image is larger than that of the moving image or if a reference block and a search range are larger, since a calculation time of the motion vector tends to increase, the effect becomes more significant.

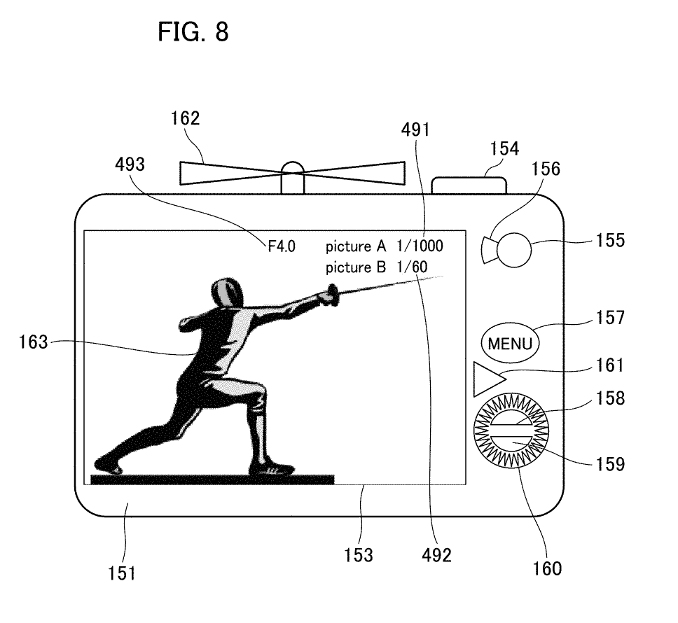

FIG. 8 is a diagram showing a state of the display unit 153 during a live view display after power is supplied to the imaging apparatus. A sports scene of a person 163 captured through the imaging optical system 152 is displayed on the display unit 153. At the same time, since the imaging mode selection lever 156 is at a position having been rotated in a clockwise direction, shutter speeds 491 and 492 for a still image (picture A) and a moving image (picture B) in a dual image mode and an F number 493 are displayed.

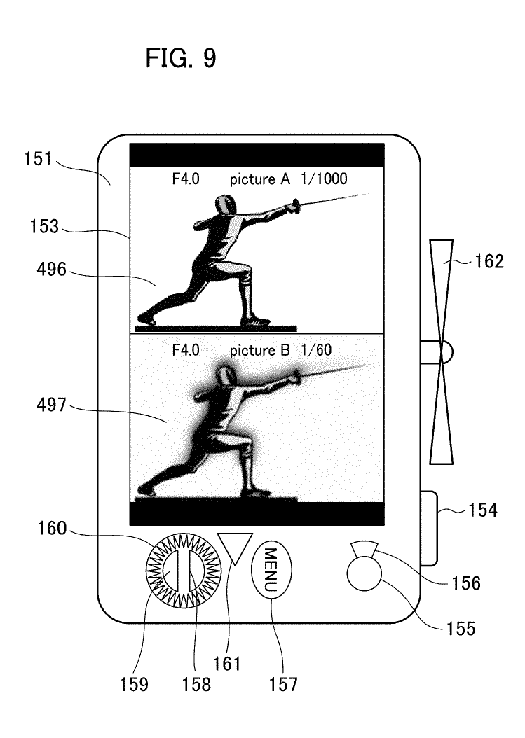

As shown in FIG. 9, when the reproduction button 161 is manipulated, both a still image (picture A) 496 and a moving image (picture B) 497 can be displayed side by side on the display unit 153 of the digital still motion camera. Accordingly, it is possible to check a level of a stop motion effect by comparing images. Here, in this process, image data may be supplied to a system or a device via a network, and a computer of the system or the device may read and execute a program.

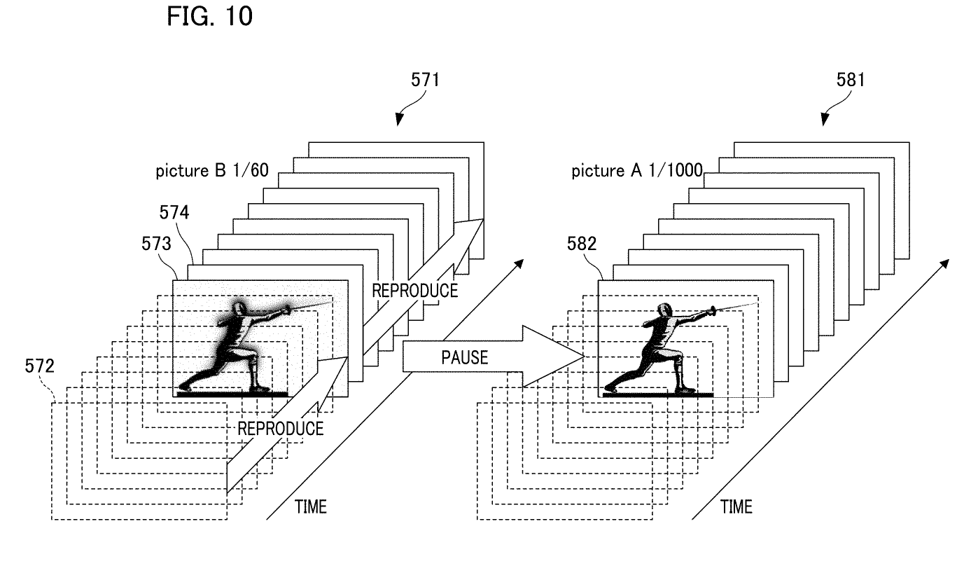

FIG. 10 is a diagram showing an application example of a still image (picture A) and a moving image (picture B) in a tablet terminal, a personal computer, a TV monitor, or the like. Data files of the still image (picture A) and the moving image (picture B) are stored in a storage or the like over a network. In FIG. 10, a frame group 581 is a frame group of a still image (picture A) stored in an MP4 file and a frame group 571 is a frame group of a moving image (picture B) stored in another MP4 file. In such MP4 files, the same CLIP-UMID as during capturing is set and association is performed.

First, when reproduction of the moving image starts, frames are sequentially reproduced at a determined frame rate from a head frame 572 of the frame group 571 of the moving image (picture B). Since the moving image (picture B) is captured in settings (in the present example, 1/60 sec) in which a shutter speed is not excessively high, the reproduced image has high quality with no impression of choppiness with frame advance.

If a user performs a pause manipulation when reproduction proceeds to a frame 573, a frame 582 with the same time code is automatically retrieved from the data file of the still image (picture A) corresponding to the moving image (picture B) and displayed. The still image (picture A) is captured at a high shutter speed (in the present example, 1/1,000 sec) at which a stop motion effect is likely to be obtained and is a powerful image in which a moment of a sports scene is captured. Even if the two images of the still image (picture A) and the moving image (picture B) are captured in settings with different accumulation periods (shutter speeds), the gain of the still image (picture A) is not increased, and the same level of the signal charge is obtained by the image element. Therefore, they are images having a favorable S/N and with no impression of noise.

Here, when printing is instructed, data of the frame 582 of the still image (picture A) is output to the printer 195 through the print interface unit 194. Therefore, the printed matter is powerful with a stop motion effect. When the user releases pausing, automatic returning to the frame group 571 of the moving image (picture B) is performed and reproduction is resumed from a frame 574. In this case, an image to be reproduced has high quality with no impression of choppiness with frame advance.

As described above, in the imaging apparatus according to the present example, while a still image and a moving image are captured at the same time with high quality, it is possible to improve calculation accuracy of the motion vector according to moving image capturing. In addition, the configuration of the present example is not limited to the example above, and can be appropriately changed in a range without departing from the spirit and scope of the present invention. For example, the calculated motion vector may be used for image processing other than shake correction, for example, compression of a moving image and tracking of a subject. As in the present example, it is possible to improve calculation accuracy of the motion vector and improve performance.

### Second Example

Next, a second example will be described. Parts the same as in the first example are denoted with the same reference numerals, and description thereof will be omitted. A main difference from the first example is that shake correction is performed by moving a part of the optical system.

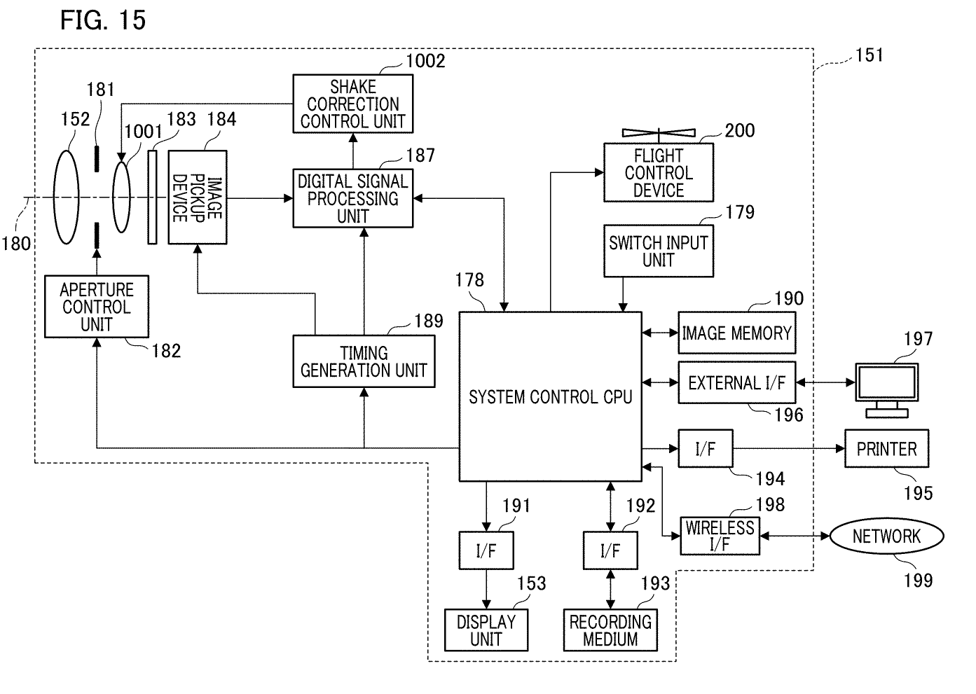

FIG. 15 is a block diagram showing the imaging apparatus 151 according to the present example. Here, the range of the imaging apparatus 151 is indicated by a dotted line. A correction lens 1001 is a part of the imaging optical system 152, and is movably held within a plane orthogonal to the optical axis 180 by a holding mechanism (not shown). When the correction lens 1001 is moved, a position of a subject image on the image element 184 can be moved within a plane orthogonal to the optical axis 180. A shake correction control unit (optical system control device) 1002 performs drive and control so that a correction lens is moved within a plane orthogonal to the optical axis 180 according to an output of the digital signal processing unit.

FIG. 16 is a diagram showing a configuration of a shake correction processing unit 1003 according to the present example. Like the motion vector calculation unit 601 in the first example, a motion vector calculation unit 1004 computes a correlation between a past frame and a current frame for a still image and outputs a motion vector. Unlike the first example, the motion vector calculated by the motion vector calculation unit 1004 is output to the shake correction control unit 1002. The shake correction control unit 1002 sets the calculated motion vector as a shake amount of the imaging apparatus, and calculates a movement amount of the correction lens 1001 necessary for cancelling out shake of the imaging apparatus. In addition, drive and control are performed so that the correction lens 1001 is moved by the calculated movement amount.

As described above, the correction lens 1001 is moved within a plane orthogonal to the optical axis 180 according to shake calculated as the motion vector, and shake of a subject image on the image element 184 is corrected. That is, in the present example, the shake correction control unit 1002 which is an optical system control device controls the optical system using the motion vector calculated from the still image which is a first image. In addition, shake correction according to the present example is updated for each imaging period, and it is possible to correct shake when the moving image is captured. Therefore, as in the first example, it is possible to improve calculation accuracy of the motion vector according to moving image capturing.

Here, in the present example, optical shake correction is performed by moving a part of the imaging optical system 152. However, optical shake correction may be performed by moving the entire imaging optical system 152 and by moving the image element 184.

### Third Example

Next, a third example will be described. Parts the same as in the first example are denoted with the same reference numerals, and description thereof will be omitted. A main difference from the first example is that a corresponding motion vector is changed according to an accumulation time of the still image.

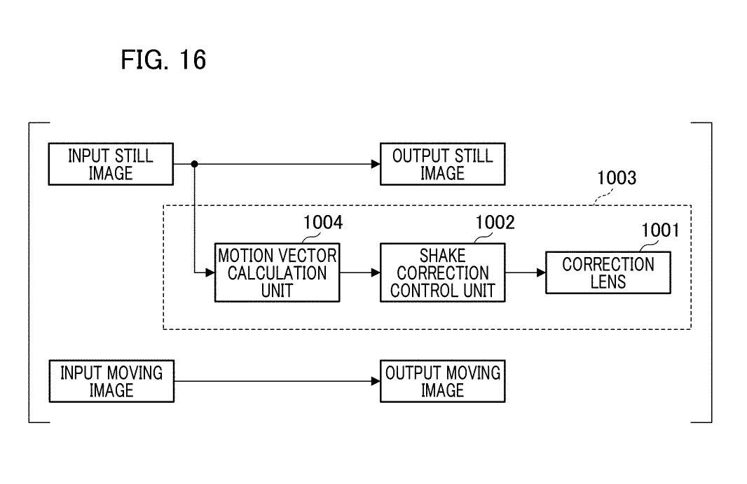

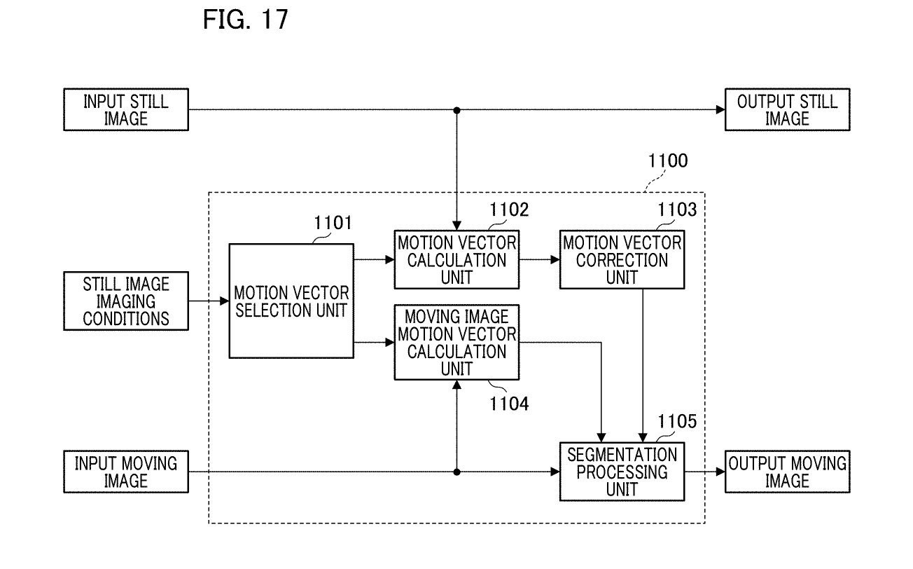

FIG. 17 is a diagram showing a configuration of a shake correction processing unit 1100 according to the present example. A motion vector selection unit (selection device) 1101 selects which of a motion vector calculation unit 1102 and a moving image motion vector calculation unit 1104 calculates a motion vector according to imaging conditions of a still image. Like the motion vector calculation unit 601 in the first example, the motion vector calculation unit 1102 computes a correlation between a past frame and a current frame for a still image and outputs a motion vector.

Like the motion vector correction unit 602 in the first example, a motion vector correction unit 1103 corrects the motion vector calculated from the still image according to a moving image and outputs it as a corrected motion vector. The moving image motion vector calculation unit (second computing device) 1104 calculates a moving image motion vector using the moving image which is a second image. Like the motion vector calculation unit 1102, the motion vector calculation unit 1104 computes a correlation between a past frame and a current frame for a moving image, and outputs a moving image motion vector. However, correction according to a moving image corresponding to the motion vector correction unit 1103 is not performed. A segmentation processing unit 1105 performs segmentation processing on the output of the moving image of the image element 184 using the corrected motion vector or the moving image motion vector based on selection of the motion vector selection unit 1101.

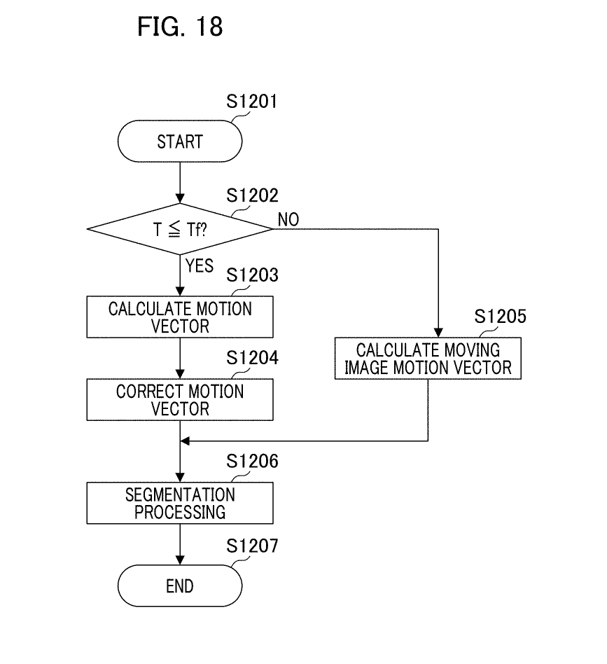

FIG. 18 is a flowchart showing operations of the shake correction processing unit 1100 according to the present example. First, in Step S1201, when shake correction processing starts, an accumulation time of still images is compared with an accumulation period of a moving image in Step S1202. As described above, an accumulation time of still images is T that corresponds to a shutter speed set by a photographer, and can be changed as indicated by T1 and T2 in FIG. 6. That is, it is possible to change a time from start of accumulation of a still image which is a first image to end thereof. In addition, an accumulation period of the moving image is Tf that corresponds to a frame rate, and is fixed at 1/60 sec.

Next, in Step S1202, it is determined whether an accumulation time T of still images is equal to or shorter than an accumulation period Tf of a moving image. If an accumulation time T of still images is equal to or shorter than an accumulation period Tf of a moving image (Yes), the process advances to Step S1203, and the motion vector calculation unit 1102 calculates a motion vector. Then, the process advances to Step S1204, the motion vector correction unit 1103 calculates a corrected motion vector, and the process advances to Step S1206. On the other hand, if an accumulation time T of still images is longer than an accumulation period Tf of a moving image in Step S1202 (No), the process advances to Step S1205, the moving image motion vector calculation unit 1104 calculates a moving image motion vector, and the process advances to Step S1206. Next, in Step S1206, the segmentation processing unit 1105 performs segmentation processing based on the corrected motion vector input in Step S1204 or the moving image motion vector input in Step S1205, and then the process advances to Step S1207, and the shake correction processing ends. When a time from start of accumulation to end thereof is shorter, image deterioration due to a movement of a subject and a movement of a camera resulting from hand shake is lowered, and an image with high sharpness is obtained.

In the present example, when a time from start of accumulation of a still image which is a first image to end thereof is longer than a time from start of accumulation of a moving image which is a second image to end thereof, shake correction processing is performed on the moving image using the motion vector calculated from the moving image which is a second image. Therefore, a motion vector can be calculated from an image having a shorter time from start of accumulation to end thereof between the still image and the moving image, that is, an image with high sharpness, and calculation accuracy of the motion vector according to moving image capturing is improved.

### Fourth Example

Next, a fourth example will be described. Parts the same as in the third example are denoted with the same reference numerals, and description thereof will be omitted. A main difference from the third example is that a corresponding motion vector is changed according to reliability of the motion vector.

There is a known method in which, when a motion vector is calculated, the reliability of the calculated motion vector is calculated at the same time (for example, corresponds to a motion vector detection unit 103 in Japanese Patent Laid-Open No. 2015-111764). A motion vector calculation unit 1302 and a moving image motion vector calculation unit 1304 according to the present example to be described below can calculate reliability from the relationship between a position of a reference block in a search range and a correlation value. The reliability may be calculated from a magnitude of a difference from an output of a gyro sensor that is provided separately.

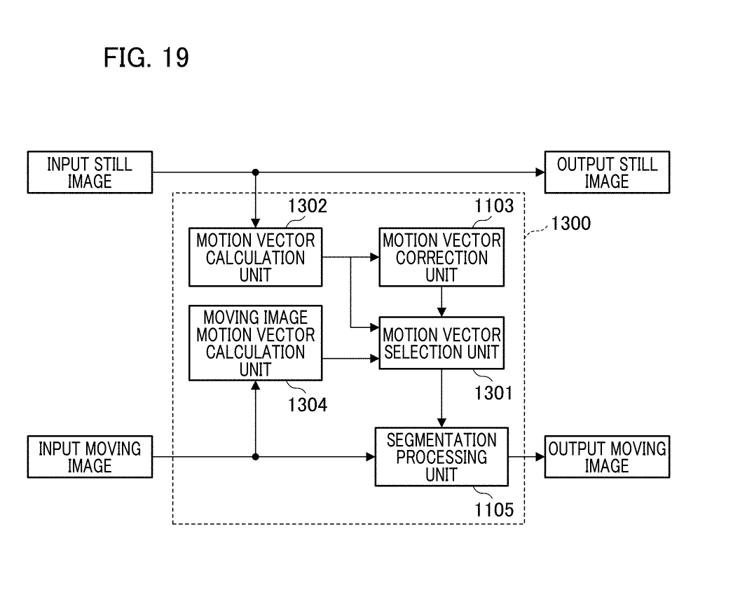

FIG. 19 is a diagram showing a configuration of a shake correction processing unit 1300 of the present example. The motion vector calculation unit 1302 outputs the motion vector and reliability of the motion vector (hereinafter defined as reliability Rs). The moving image motion vector calculation unit 1304 calculates the moving image motion vector and a reliability of the moving image motion vector (hereinafter defined as reliability Rm). A motion vector selection unit 1301 compares the reliability of the motion vector with the reliability of the moving image motion vector, and selects and outputs either the motion vector or the moving image motion vector.

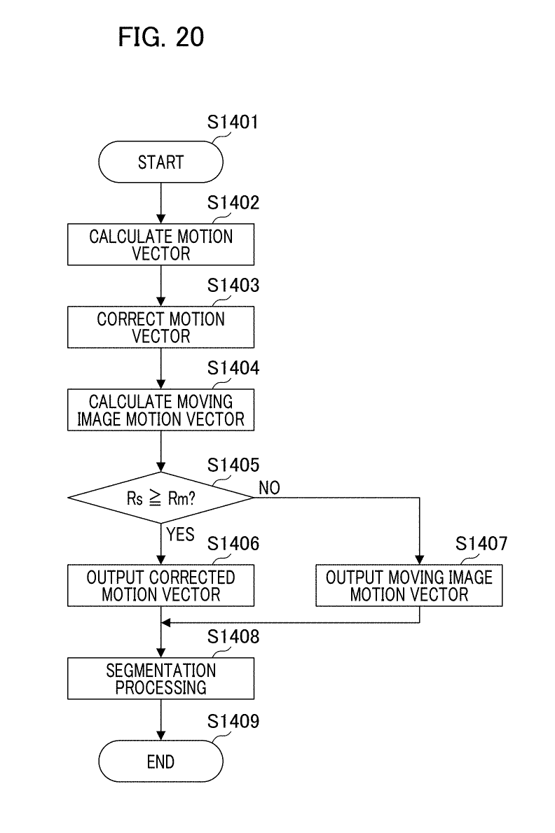

FIG. 20 is a flowchart showing operations of the shake correction processing unit 1300 according to the present example. First, in Step S1401, when shake correction processing starts, the motion vector calculation unit 1302 calculates a motion vector and reliability in Step S1402. Almost at the same time, in Step S1403, a motion vector correction unit 1303 calculates a corrected motion vector. Next, in Step S1404, the moving image motion vector calculation unit 1304 calculates a moving image motion vector and a reliability. Next, in Step S1405, the reliability Rs of the motion vector is compared with the reliability Rm of the moving image motion vector. Then, in Step S1405, if the reliability Rs of the motion vector is equal to or higher than the reliability Rm of the moving image motion vector (Yes), in Step S1406, the corrected motion vector is output from the motion vector selection unit 1301. On the other hand, if the reliability Rs of the motion vector is lower than the reliability Rm of the moving image motion vector in Step S1405 (No), in Step S1407, the moving image motion vector is output from the motion vector selection unit 1301. Then, in Step S1408, segmentation processing is performed, and then the process advances to Step S1409, and the shake correction processing ends.

In the present example, the motion vector calculation unit 601 which is a first computing device and the motion vector correction unit 602 can calculate the reliability Rm of the motion vector calculated from a plurality of still images which are a plurality of first images. In addition, the moving image motion vector calculation unit 1304 which is a second computing device can calculate the reliability Rm of the motion vector calculated from a plurality of moving images which are a plurality of second images. In addition, when the reliability Rs is lower than the reliability Rm, the shake correction processing unit 1300 which is an image processing device performs shake correction processing on the moving image using the motion vector calculated by the moving image motion vector calculation unit 1304 which is a second computing device. Therefore, a motion vector with higher reliability between the motion vectors calculated from the still image and the moving image can be selected and calculation accuracy of the motion vector according to moving image capturing is improved.

The configuration of the present invention is not limited to the above examples, and can be appropriately changed in a range without departing from the spirit and scope of the present invention. For example, a configuration in which an area on the image element 184 is divided and a still image is captured in a certain area and a moving image is captured in another area may be used. In addition, a configuration in which a plurality of image elements are included, a still image is captured by a certain image element and a moving image is captured by another image element may be used. In this case, an optical path is divided midway, and a plurality of image elements may be arranged on different imaging planes or a plurality of image elements may be arranged on the same imaging plane. According to the above configuration, it is possible to accumulate a still image and a moving image at the same time and increase a degree of freedom of imaging sequences.

### Second Invention

In the related art, there is a known technique for performing capturing by reducing the transmittance according to an imaging light intensity in order to perform capturing under an extremely light environment in an imaging apparatus such as a digital camera. Light reduction is performed in order to realize subject display with a shallow depth of field by opening an aperture under a light environment, or display a subject movement trajectory, for example, waterfall water, without causing saturation even if a long-time exposure is performed. As a method of performing light reduction, a method using an ND filter is known. In addition, in Japanese Patent Laid-Open No. 2015-136087, a technology for reducing light by dividing an exposure time for an image element according to time is disclosed.

However, in the imaging apparatus in Japanese Patent Laid-Open No. 2015-136087, if a plurality of image data items acquired from a separate exposure are added and synthesized to acquire image data with reduced light, and a subject that moves is imaged, there is a risk of a movement of the subject being interrupted, which results in an unnatural image.

The second invention proposes an imaging apparatus that can capture a high-quality image even if a subject moves during a separate exposure.

The imaging apparatus 10 to which the second invention is applied is the same as in the first invention. Here, the imaging apparatus 10 will be described again with reference to FIG. 1 to FIG. 3.

FIG. 1 shows external appearance views of the imaging apparatus 10. FIG. 1A is a front view of the imaging apparatus 10 and FIG. 1B is a rear view of the imaging apparatus 10. The imaging apparatus 10 is, for example, a digital motion camera that can capture a still image and a moving image. In the present example, an example of an imaging apparatus in which an imaging apparatus body and a lens are integrated has been described. However, the present invention is not limited thereto. For example, a lens interchangeable digital single-lens reflex camera may be used. The imaging apparatus 10 includes the imaging apparatus body 151, the imaging optical system 152, the display unit 153, the switch ST 154 and the propeller 162. In addition, the imaging apparatus 10 includes the switch MV 155, the selection lever 156, the menu button 157, the up switch 158, the down switch 159, the dial 160 and the reproduction button 161.

The imaging apparatus body 151 is a body part of the imaging apparatus 10 in which an image element and a shutter device are accommodated. The imaging optical system 152 is an imaging optical system having a lens and an aperture therein. The display unit 153 is a movable display unit configured to display imaging information and an image. The display unit 153 has a display luminance range in which an image having a wide dynamic range can be displayed without reducing the luminance range. The switch ST 154 is a shutter button that is used for mainly capturing a still image. The propeller 162 is a propeller for causing the imaging apparatus 10 to rise into the air in order to perform imaging in the air.

The switch MV 155 is a button for starting and stopping capturing of a moving image. The selection lever 156 is a selection lever in an imaging mode for selecting an imaging mode. The menu button 157 is a menu button for performing transition to a function setting mode in which a function of the imaging apparatus 10 is set. The up switch 158 and the down switch 159 are up and down switches for changing various setting values. The dial 160 is a dial for changing various setting values. The reproduction button 161 is a button for performing transition to a reproduction mode in which an image recorded in a recording medium in the imaging apparatus 10 is reproduced on the display unit 153.

FIG. 2 is a block diagram showing a schematic configuration of the imaging apparatus 10. The imaging apparatus 10 includes the imaging optical system 152, the aperture 181, the aperture control unit 182, the optical filter 183, the image element 184, the digital signal processing unit 187, the timing generation unit 189 and the system control unit 178. In addition, the imaging apparatus 10 includes the display I/F 191, the display unit 153, the recording I/F unit 192, the recording medium 193, the wireless I/F 198, the print I/F 194 and the external I/F 196. In addition, the imaging apparatus 10 includes the image memory 190, the switch input unit 179, and the flight control device 200.

The imaging optical system 152 forms an optical image of a subject on the image element 184. The optical axis 180 is an optical axis of the imaging optical system 152. The aperture 181 is an aperture for adjusting an intensity of light that passes through the imaging optical system 152 and is controlled by the aperture control unit 182. The optical filter 183 limits wavelengths of light that enters the image element 184 and a spatial frequency that is transmitted to the image element 184. The image element 184 converts the optical image of the subject formed through the imaging optical system 152 into an electrical image signal (signal charge) in a photoelectric conversion unit. The image element 184 has a sufficient number of pixels, a signal reading speed, a color gamut, and a dynamic range which satisfy ultra high definition television standards.

The digital signal processing unit 187 performs various types of correction on digital image data acquired from the image element 184 and then compresses the image data. The timing generation unit 189 outputs various timing signals to the image element 184 and the digital signal processing unit 187 and controls various timings. The system control unit 178 is a CPU that performs various types of computing and controls the entire imaging apparatus 10. In addition, the system control unit 178 is used to identify a subject from the image processed in the digital signal processing unit 187 and detect a movement speed on the image plane of the subject. That is, the digital signal processing unit 187 and the system control unit 178 have a function of a speed detection device configured to detect a movement speed on the image plane of the subject from imaging results.

The display I/F 191 is an interface for displaying a captured image on the display unit 153. The display unit 153 is a display unit such as a liquid crystal display. The recording I/F unit 192 is an interface for performing recording or reading in or from the recording medium 193. The recording medium 193 is a removable recording medium such as a memory for recording image data, additional data, and the like. The wireless I/F 198 is an interface for communication via the external network 199. The network 199 is a computer network such as the Internet. The print I/F 194 is an interface for outputting to and printing a captured image on the external printer 195. The printer 195 is a printer such as a small ink jet printer. The external I/F 196 is an interface for communication with the external device 197 and the like. The external device 197 is a device that can display an image of a computer or a TV.

The image memory 190 temporarily stores image data. The switch input unit 179 includes the switch ST 154, the switch MV 155, and a plurality of switches for switching between various modes, and receives manipulations by a photographer. In addition, the switch input unit 179 also has a function as a light intensity setting unit that receives a setting of the number of stages of neutral density (ND) which is a light intensity limit amount. The number of ND stages (light reduction stage number) is a value that corresponds to an optical density (light transmittance). The flight control device 200 is a flight control device for performing capturing in the air.

FIG. 3 is a circuit diagram showing a configuration of a pixel of the image element 184. The image element 184 includes a plurality of pixel elements (pixel parts) that are two-dimensionally arranged. In FIG. 3, among a plurality of pixel elements of the image element 184, a pixel element 50 of the 1^{st} row and 1^{st} column (1,1) and a pixel element 51 of the m-th row and 1^{st} column (m,1) which is the last line are shown. Since the pixel element 50 and the pixel element 51 have the same configuration, components of the pixels are denoted with the same reference numerals.

One pixel element of the image element 184 includes two signal holding units (the first signal holding unit 507A and the second signal holding unit 507B) for one photodiode 500. The signal holding units can accumulate charges at different timings and read different images. In the present example, the first signal holding unit 507A accumulates a signal charge for imaging, and the second signal holding unit 507B accumulates a signal charge for detecting a speed of a subject. That is, an image for capturing (first image) is generated from the signal charge accumulated in the first signal holding unit 507A and an image for detecting a speed of a subject (second image) is generated from the signal charge accumulated in the second signal holding unit 507B.

Since a basic structure of the image element 184 including signal holding units is disclosed in Japanese Patent Laid-Open No. 2013-172210 by the applicants, description thereof will be omitted. Since the image element 184 of the present example includes two signal holding units for one photodiode 500, it is possible to read two images with different accumulation periods without reducing S/N. Here, in the present example, an example in which two signal holding units are included will be described. However, the present invention is not limited thereto, and a plurality of signal holding units may be included.

The pixel element 50 includes the photodiode 500 which is a photoelectric conversion unit, and the first signal holding unit 507A and the second signal holding unit 507B. In addition, the pixel element 50 includes the first transfer transistor 501A, the second transfer transistor 502A, the third transfer transistor 501B, the fourth transfer transistor 502B, and the fifth transfer transistor 503. In addition, the pixel element 50 includes the reset transistor 504, the amplifying transistor 505, the select transistor 506 and the floating diffusion region 508. In addition, the power line 520, the power line 521 and the signal output line 523 are included in the pixel element 50.

The first transfer transistor 501A is controlled by a transfer pulse φTX1A. The second transfer transistor 502A is controlled by a transfer pulse φTX2A. The third transfer transistor 501B is controlled by a transfer pulse φTX1B. The fourth transfer transistor 502B is controlled by a transfer pulse φTX2B. The fifth transfer transistor 503 is controlled by a transfer pulse φTX3. The reset transistor 504 is controlled by a reset pulse φRES. The select transistor 506 is controlled by a select pulse φSEL. Here, control pulses are transmitted from a vertical scanning circuit (not shown).

According to the transfer pulse φTX3 used for controlling the fifth transfer transistor 503, the photodiode 500 is reset, and an accumulation start timing is determined. In addition, according to the transfer pulse φTX1A used for controlling the first transfer transistor 501A, a timing at which a charge accumulated in the photodiode 500 is transferred to the first signal holding unit 507A is determined. According to the transfer pulse φTX1B used for controlling the third transfer transistor 501B, a timing at which a charge accumulated in the photodiode 500 is transferred to the second signal holding unit 507B is determined. Here, control pulses are transmitted from a vertical scanning circuit (not shown).

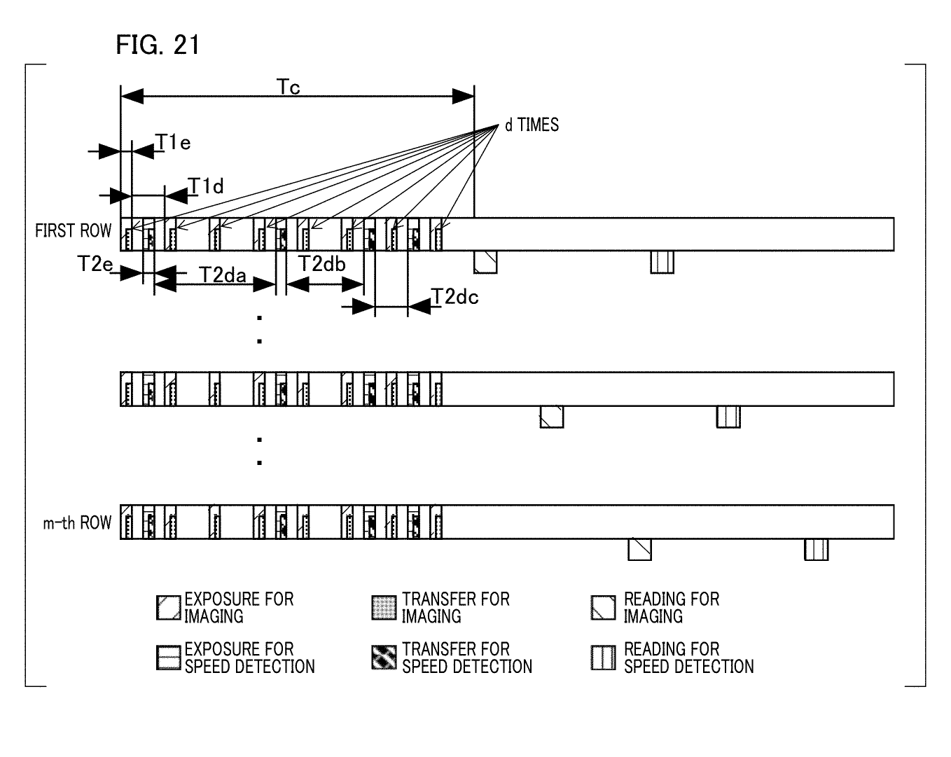

FIG. 21 is a sequence diagram showing from exposure to reading in one imaging. A flow of time is shown in the horizontal direction, a line marked as the first row indicates a sequence in a pixel element of the 1st row and 1st column (1,1), and up to the m-th row is shown. A total exposure time Tc corresponds to one imaging period. Within the total exposure time Tc, the same sequence is shown from the 1^{st} row to the m-th row. A part on the right side of the total exposure time Tc shows signal reading, and the sequence is sequentially read from the 1st row to the m-th row. In FIG. 21, right upward oblique lines indicate an exposure for imaging and a horizontal line indicates an exposure for speed detection. Small dots indicate transfer for imaging and large dots indicate transfer for speed detection. Left upward oblique lines indicate reading for imaging, and the vertical line indicates reading for speed detection.

In the present example, imaging in which the total exposure time Tc is divided to provide two stages of an ND effect will be described. One separate exposure is set as a first exposure time T1e. The first exposure time T1e is an exposure time for imaging. The first exposure time T1e represents a time from when the photodiode 500 is reset according to the transfer pulse φTX3 and accumulation starts until the charge is transferred to the first signal holding unit 507A according to the transfer pulse φTX1A. On the other hand, a first non-exposure time T1d is a time during which no imaging for one separate exposure occurs. The first non-exposure time T1d is a time from when transfer according to the immediately preceding transfer pulse φTX1A occurs until accumulation starts after resetting according to the transfer pulse φTX3 which is performed before transfer according to the next transfer pulse φTX1A.

The charge obtained in the photodiode 500 in the first exposure time T1e is transferred to the first signal holding unit 507A each time. When the total exposure time Tc is completed, all charges accumulated in a plurality of first exposure times T1e are transferred to the first signal holding unit 507A. The signal accumulated in the first signal holding unit 507A is read after the total exposure time Tc ends, and an image for capturing is generated.

A transfer count d represents the number of transfers of signal charges from the photodiode 500 to the first signal holding unit 507A in one imaging period (the total exposure time Tc), that is, the number of exposures for imaging. In the present example, transfer of signal charges from the photodiode 500 to the first signal holding unit 507A is performed twice or more during one imaging period (the total exposure time Tc) in order to obtain an ND effect. In FIG. 21, during the total exposure time Tc, the first exposure time T1e and the first non-exposure time T1d are repeated eight times. Therefore, the transfer count d of charges from the photodiode 500 to the first signal holding unit 507A is 8.

In order to obtain two stages of an ND effect, a relationship of Tc/(2̂2 stages)=ΣT1e is established. Here, Σ is used to indicate a sum of a plurality of first exposure times T1e. In addition, a relationship of Tc=ΣT1e+ΣT1d is established. In the present example, the same first exposure time T1e and the same first non-exposure time T1d are repeated eight times. This is because, if a subject that moves is imaged, a time is uniformly divided and light from the subject is acquired so that no unevenness of a movement trajectory is caused. The transfer count d, the first exposure time T1e, and the first non-exposure time T1d may be changed within a range in which the above formula is established. When the transfer count d is changed according to a movement speed of a subject, it is possible to capture a moving subject with high quality. On the other hand, for a subject that does not move, a time may be separately increased and decreased during one imaging.

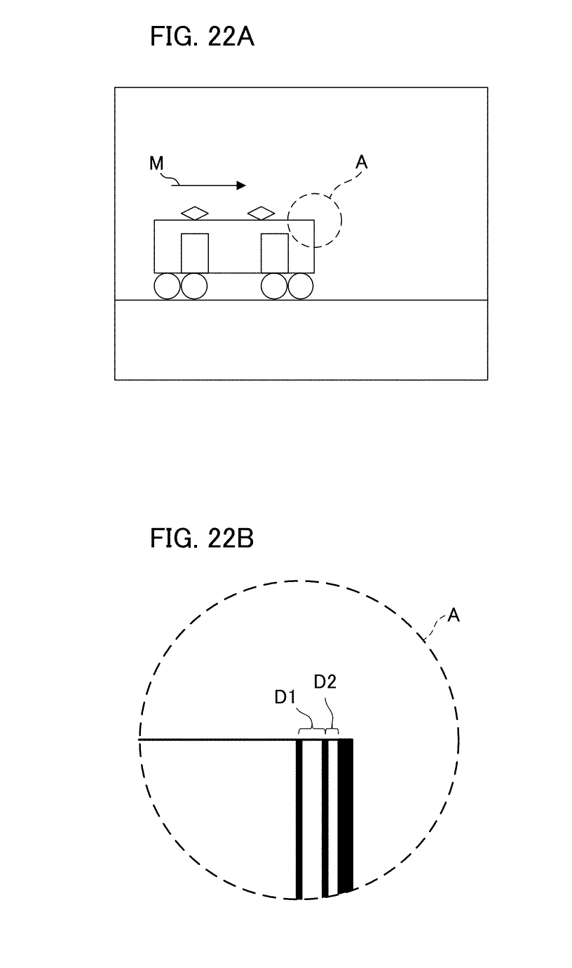

Next, an exposure for speed detection will be described with reference to FIG. 21 and FIG. 22. A second exposure time T2e is an exposure time for speed detection. The second exposure time T2e represents a time from when the photodiode 500 is reset according to the transfer pulse φTX3 and accumulation starts until the charge is transferred to the second signal holding unit 507B according to the transfer pulse φTX1B. It is desirable that the second exposure time T2e be set within a range in which light of a subject can be captured by photometry or the like. On the other hand, a second non-exposure time T2d is a time during which no one separate exposure for speed detection occurs. The second non-exposure time T2d is a time from when transfer according to immediately preceding transfer pulse φTX1B occurs until accumulation starts after resetting according to the transfer pulse φTX3 which is performed before transfer according to the next transfer pulse φTX1B.

In imaging for speed detection, during one imaging period (the total exposure time Tc), the number of transfers of signal charges from the photodiode 500 to the second signal holding unit 507B is 3 or more. In the example shown in FIG. 21, an exposure for speed detection is performed 4 times during one imaging period. The same time is set for the second exposure times T2e during one imaging period. On the other hand, unlike the exposure for imaging, the second non-exposure times T2d during one imaging period are set to a plurality of lengths by changing the time. In the present example, as the second non-exposure time T2d, second non-exposure times T2da to T2dc with different times are set. When the lengths of respective times are compared, T2da≅T2db≅T2dc is established. Here, the second non-exposure time T2dc is the same as the first non-exposure time T1d. On the other hand, the same time is set for the first non-exposure time during one imaging period.

FIG. 22 shows diagrams of results of imaging for speed detection. A train that moves in a direction of an arrow M as shown in FIG. 22A is captured. FIG. 22B is a diagram showing a state in which a part A surrounded by a broken line circle is observed in detail. Since imaging for speed detection is performed a plurality of times during one imaging period as shown in FIG. 21, a plurality of black lines indicating an end of the train appear. Among three black lines indicating an end of the train, the left side corresponds to the first exposure, the center corresponds to the second exposure, and the right side corresponds to the third and fourth exposures. Therefore, a non-exposure part D1 corresponds to the second non-exposure time T2da. In addition, a non-exposure part D2 corresponds to the second non-exposure time T2db. Here, since the second non-exposure time T2dc is short, in the observation range, an unexposed part is not noticeable and a picture causing no unease is obtained.

When a length by which a subject moves on the image element is associated with the known second non-exposure time T2d, it is possible to calculate a movement speed of the subject on the image element. In this case, when a time of the second non-exposure time T2d is set to a plurality of lengths, it is possible to perform observation in a wide range according to an unknown movement speed of the subject. In addition, if a non-exposure time is short like the second non-exposure time T2dc, it is possible to determine that no unease is caused in observation of imaging results. Here, lengths of times of the second non-exposure time T2d are compared and described, but this similarly applies to times of the first non-exposure time T1d. That is, if a movement speed of a subject is high, it is possible to capture imaging results with high quality in which a movement of the subject is not interrupted by reducing the first non-exposure time T1d.

The calculated movement speed of the subject is used to determine a method of dividing an exposure in the next imaging. For example, in a consecutive imaging scene in which the first exposure and the next exposure are continuous, since a change in movement speed of the subject is considered not to be large, it is effective to determine a method of dividing the next exposure on the basis of the movement speed of the subject calculated in the first imaging. While a movement speed is detected at the same time as imaging in the present example, it is possible to detect a movement speed during live view before imaging. In addition, while a movement speed of the subject is detected from the image in the present example, it may be calculated from an accelerometer built into the image element and may be input in the imaging apparatus in advance.

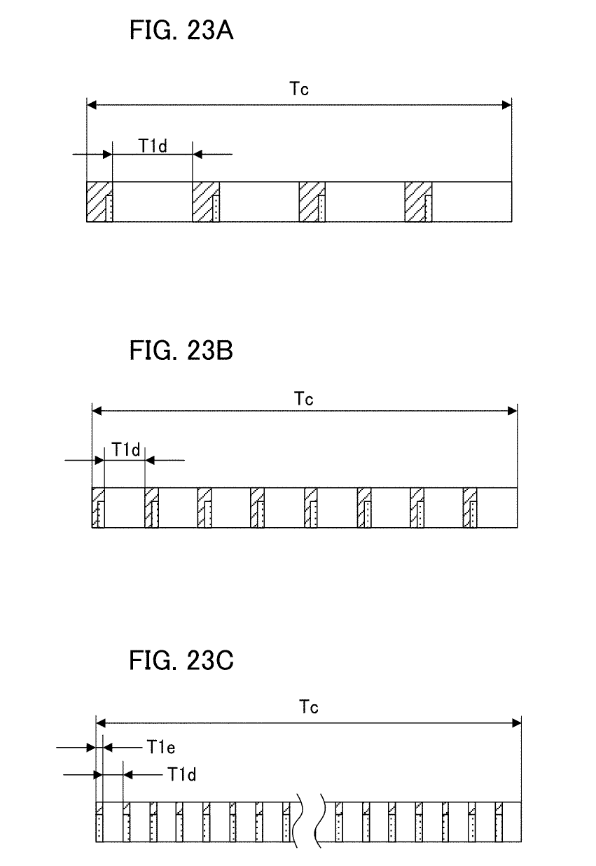

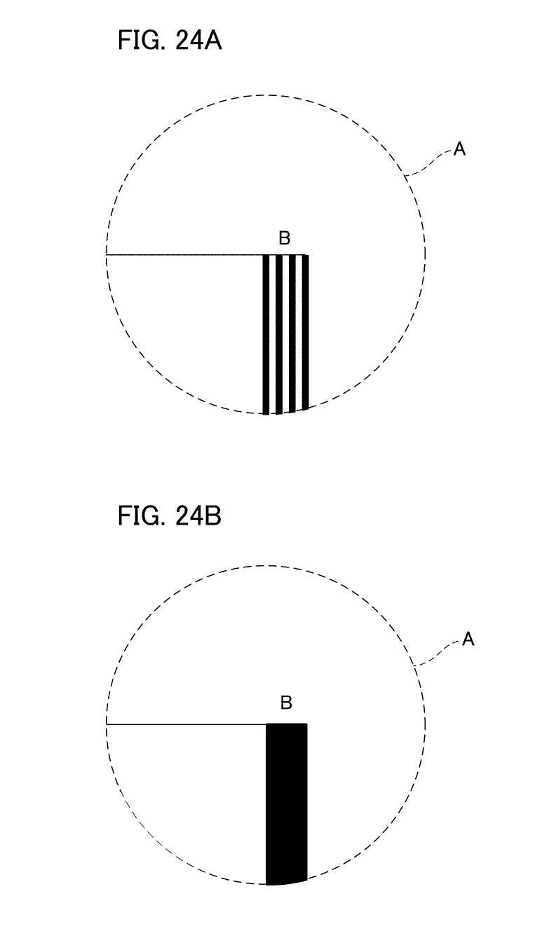

Next, a division state and imaging results will be described with reference to FIG. 21, FIG. 23 and FIG. 24. FIG. 23 shows diagrams of sequences if the first non-exposure time T1d for imaging is changed. FIG. 23A shows a case in which the transfer count d is 4 which is half that of the sequence in FIG. 21. FIG. 23B shows the same sequence as in FIG. 21. In FIG. 23B, the transfer count d is 8. In FIG. 23C, the transfer count d is increased with respect to the sequence of FIG. 21. Therefore, the first non-exposure time T1d in the sequence in FIG. 23A is twice the first non-exposure time T1d in FIG. 23B. In addition, the first exposure time T1e and the first non-exposure time T1d in FIG. 23C can be set to the shortest executable time. Since switching between transfer pulses, transfer of charges, or the like takes a finite time although it is a short time, there is a structural limit to the shortest time of the first exposure time T1e and the first non-exposure time T1d.

FIG. 24 shows diagrams in which a part A surrounded by a broken line circle in FIG. 22A is observed in detail. FIG. 24A shows an imaging result if an exposure time is divided as in FIG. 23A. FIG. 24B shows an imaging result if an exposure time is divided as in FIG. 23B.

When the first non-exposure time T1d is set to be longer as in the sequence in FIG. 23A, as shown in FIG. 24A, a part which is not exposed to a blurred part B is clearly displayed, which results in an unnatural picture.

The first non-exposure time T1d in the sequence in FIG. 23B is the same as the second non-exposure time T2dc in the sequence in FIG. 21. As described with reference to FIG. 22B, the second non-exposure time T2dc is a non-exposure time of a level at which no unease is caused in observation of imaging results. Therefore, also in the imaging result of the sequence in FIG. 23B in which the same first non-exposure time T1d as the second non-exposure time T2dc is repeated, as shown in FIG. 24B, no non-exposure time appears in the image, the blurred part B becomes substantially uniform and an image causing no unease is obtained. Therefore, if imaging is performed for a shorter non-exposure time than the first non-exposure time T1d in FIG. 23B, it is possible to capture a high-quality picture.

In the sequence in FIG. 23C, a case in which the first exposure time T1e and the first non-exposure time T1d are set to the shortest possible times is shown. Since a certain finite time is required for control by the image element 184 such as for transfer of charges, there is a limit to shortening the first exposure time T1e and the first non-exposure time T1d. While an imaging result corresponding to the sequence in FIG. 23C is not shown, since the first non-exposure time T1d is shorter than in FIG. 23B, as shown in FIG. 24B, no non-exposure time appears in the image, the blurred part B becomes substantially uniform and an image causing no unease is obtained.

Also in the sequence in FIG. 23B, a picture with sufficiently high quality in which no non-exposure time appears in the image is obtained, and when the first non-exposure time T1d is shortened as in FIG. 23C, a quality improvement effect is weak. On the other hand, when the first non-exposure time T1d is shortest, the transfer count d increases. When the transfer count d increases, transfer of charges is repeated many times, and power for controlling the image element increases. In addition, one exposure time is also influenced by variation in timing within the image element 184. If the transfer count d is large even if one timing variation is small, an influence is amplified and the total exposure time varies greatly. Therefore, in consideration of power reduction and exposure time variation reduction, the transfer count d is preferably as small as possible. That is, for the first non-exposure time T1d, the maximum non-exposure time may be set in a range in which no non-exposure time appears in the image.

Setting conditions of the first non-exposure time T1d are expressed by the formula of “V×T1d<Const.” Here, V denotes a speed of a subject on an image plane, and Const. is a value that is determined from imaging conditions such as a subject distance and a focusing state, and observation conditions. It is desirable that T1d be set to be longer in a range in which the formula is satisfied. This formula means that it is necessary to shorten the first non-exposure time T1d as a speed V of the subject on the image plane becomes higher. That is, if a speed V of a subject on the image plane is higher, the first non-exposure time T1d may be shortened and the transfer count d may be increased. On the other hand, if a speed V of a subject on the image plane is slower, the first non-exposure time T1d may be lengthened in a range in which the above formula is satisfied and the transfer count d may be decreased.

If a speed V of a subject on the image plane increases, it is necessary to shorten the first non-exposure time T1d. However, as described above, there is a limit to shortening the first non-exposure time T1d. The first exposure time T1e and the first non-exposure time T1d have a relationship of (T1e+T1d)/T1e=2̂n when the number of ND stages is set as n. Therefore, if the number of ND stages is 2, when the first exposure time T1e is set to be shortest, the first non-exposure time T1d is also set to be shortest. When the number of ND stages is larger, the first non-exposure time T1d increases with respect to the first exposure time T1e. On the other hand, when the number of ND stages is smaller, it is possible to shorten the first non-exposure time T1d with respect to the first exposure time T1e. Therefore, if a movement speed of a subject is higher than a predetermined value, the number of ND stages is reduced and the transfer count d is increased so that it is possible to shorten the first non-exposure time T1d.

When the number of ND stages is changed, since an intensity of light to be captured changes greatly, it is necessary to limit a light intensity such as shortening an imaging time and lowering an ISO sensitivity. In addition, a photographer can select in advance either a subject speed priority mode in which, even if the number of ND stages is small, a subject that moves is imaged with high quality or an ND stage number priority mode in which setting of the number of ND stages has a priority regardless of a quality of a moving subject. If the subject speed priority mode is selected, when a speed of a subject is high, the imaging apparatus 10 reduces the number of ND stages, increases the transfer count d, and shortens the first non-exposure time T1d. On the other hand, if the ND stage number priority mode is selected, even when a speed of a subject is high, the number of ND stages is not decreased to shorten the first non-exposure time T1d.

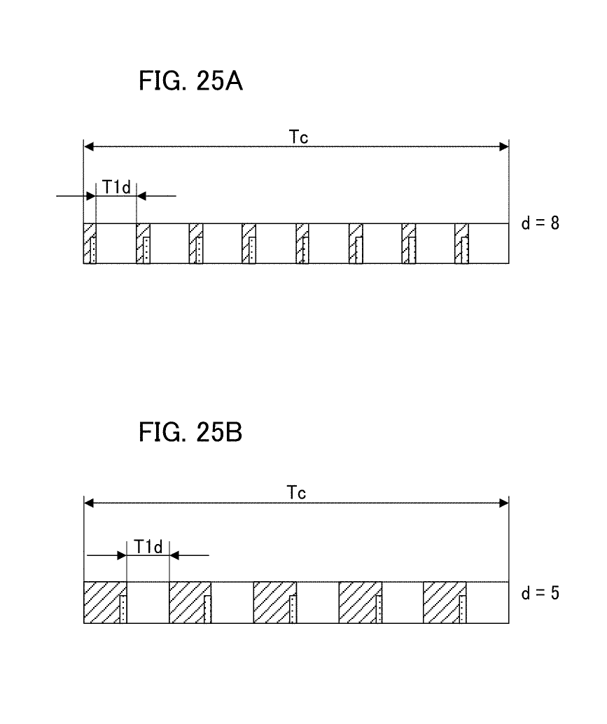

FIG. 25 shows sequences from exposure to reading in one imaging. FIG. 25A shows a case in which the number of ND stages is 2. FIG. 25B shows a case in which the number of ND stages is 1. The first non-exposure time T1d in FIG. 25A is the same as the first non-exposure time T1d in FIG. 23B. As described above, if the number of ND stages is 2, when the length of the first non-exposure time T1d shown in FIG. 25A is set, it is possible to capture a high-quality picture while realizing power reduction and exposure time variation reduction. The transfer count d in this case is 8.

When the number of ND stages is changed from 2 to 1, if the number of ND stages is changed while the transfer count d remains at 8, the first non-exposure time T1d is shortened. When the first non-exposure time T1d is shortened, capturing of a high-quality picture can be realized. However, as described above, the first non-exposure time T1d is preferably set to be as long as possible in a range in which no non-exposure time appears in the image. Thus, as shown FIG. 25B, when the transfer count d is changed to 5, the first non-exposure time T1d can be substantially the same as in a case in which the number of ND stages is 2 and the transfer count d is 8. That is, if the number of ND stages is small, it is possible to capture a high-quality picture by reducing the transfer count d. In this manner, it is possible to capture a high-quality picture in which a movement of a subject is not interrupted while realizing power reduction and exposure time variation reduction by changing the number of transfers according to the number of ND stages which is a light intensity limit amount.

As described above, according to the present example, it is possible to provide an imaging apparatus that can capture a high-quality picture by determining a non-exposure time according to a speed of a subject even if the subject moves during a separate exposure.

### Other Examples

The second invention can be realized in processes in which a program that executes one or more functions of the above example is supplied to a system or a device through a network or a storage medium, and one or more processors in a computer of the system or the device read and execute the program. In addition, the second invention can be realized by a circuit (for example, an ASIC) that implements one or more functions.

### Third Invention

In recent years, image elements have become highly functional, and improvements in the number of pixels and a frame rate have been attempted. There is a known method in which vector data (optical flow) indicating a movement of an object between a plurality of images is obtained using this signal. For example, the optical flow is an index that indicates an amount and direction of hand shake in capturing of a moving image, and is used to calculate a segmentation amount and a direction in electronic vibration prevention according to image segmentation from a large captured image. In addition, the optical flow is an index for estimating a movement direction and a speed of a subject that moves, and is used for tracking auto focus and the like.

The optical flow is acquired when movement amounts and directions of an object between images of preceding and following frames in the moving image are calculated by comparing the images. In this case, when a movement of a subject and hand shake is fast and an object moves greatly during an exposure time for one frame, an image of the object obtained as a result of the exposure becomes blurred in the movement direction. When comparing the blurred object images, since an outline of the object image is not clear, there are problems in that it is not possible to accurately compare positions and it is not possible to precisely obtain an optical flow that indicates a movement amount and a movement direction of an object between images.

In the imaging apparatus in Japanese Patent Laid-Open No. 2010-206522, in order to address the above problem, it is proposed that a shutter speed per one frame when a moving image is captured be set to be higher according to a speed of an object to be captured and an exposure time be shortened so that an image in which the outline of the object is sharp is obtained. In the imaging apparatus in Japanese Patent Laid-Open No. 2010-157893, it is proposed that charges converted by a photoelectric conversion unit are transferred to an accumulation unit a plurality of times and the charges that are transferred a plurality of times are collectively accumulated so that it is possible to change conditions such as an exposure time and an exposure amount at a high speed and freely. In addition, using this, in one frame period, short accumulation periods are uniformly distributed in one frame period and charges that are transferred a plurality of times are collectively accumulated so that a moving image can be obtained.

In the imaging apparatus in Japanese Patent Laid-Open No. 2010-206522, it is possible to obtain a sharp image of an object that moves fast by increasing a shutter speed in one frame during capturing a moving image and shortening an exposure time. However, increasing a shutter speed in moving image capturing has the following disadvantages. Generally, it is known that quality greatly deteriorates when there is a type of impression of choppiness with frame advance in a reproduced moving image. In order to avoid such an impression of choppiness, it is necessary to set an accumulation time close to one frame period in a capturing sequence. That is, when the frame rate is 30 fps, a relatively long exposure time such as 1/30 sec or 1/60 sec is appropriate. That is, an operation of obtaining a sharp image by increasing a shutter speed during capturing a moving image and shortening an exposure time in one frame has a problem that an impression of choppiness is likely to be experienced in a moving image in contrast to a relatively long exposure time that is set close to the one frame period.

In addition, in the imaging apparatus in Japanese Patent Laid-Open No. 2010-157893, when an exposure for a short time and transmission to an accumulation unit are repeated at plurality of times in one frame period, it is possible to perform imaging for a relatively long exposure time while a light intensity is reduced. In addition, since the image obtained accordingly is an overlapping image obtained by performing an exposure and transmission to an accumulation unit a plurality of times, compared to the imaging apparatus in Japanese Patent Laid-Open No. 2010-206522, there is less impression of choppiness when viewed as a moving image. However, in the imaging apparatus in Japanese Patent Laid-Open No. 2010-157893, since obtaining of an optical flow is not assumed, it is not a multiple division accumulation method suitable for precisely obtaining the optical flow. In addition, if the imaging apparatus in Japanese Patent Laid-Open No. 2010-157893 is operated to acquire an optical flow, when images are compared between frames, outlines of these images overlap each other. Accordingly, there are problems in that it is difficult to accurately select outlines that are common between frames therefrom and it is not possible to perform precise detection.

A third invention provides an imaging apparatus that can prevent a user from experiencing an impression of choppiness and obtain an optical flow with high accuracy and a control method thereof.

### <Imaging Apparatus>

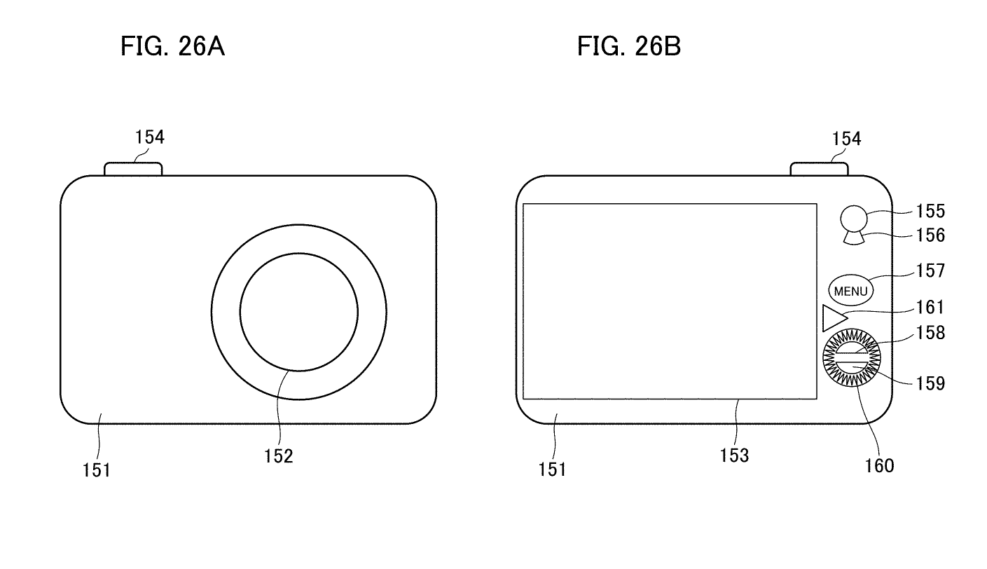

FIG. 26A and FIG. 26B show external appearance views of a digital still motion camera as an imaging apparatus in an embodiment of the present invention. FIG. 26A is a front view of the imaging apparatus and FIG. 26B is a rear view of the imaging apparatus. In these drawings, 151 indicates an imaging apparatus body in which an image element and a shutter device are accommodated. 152 indicates an imaging optical system having an aperture therein. 153 indicates a movable display unit configured to display imaging information and an image. 154 is a switch ST that is used for mainly capturing a still image. 155 indicates a switch MV which is a button for starting and stopping capturing of a moving image. The display unit 153 has a display luminance range in which an image having a wide dynamic range can be displayed without reducing the luminance range. 156 indicates an imaging mode selection lever for selecting an imaging mode. 157 indicates a menu button for performing transition to a function setting mode in which a function of the imaging apparatus is set. 158 and 159 indicate up and down switches for changing various setting values. 160 indicates a dial for changing various setting values. 161 indicates a reproduction button for performing transition to a reproduction mode in which an image recorded in a recording medium which is accommodated in the imaging apparatus body is reproduced on the display unit 153.

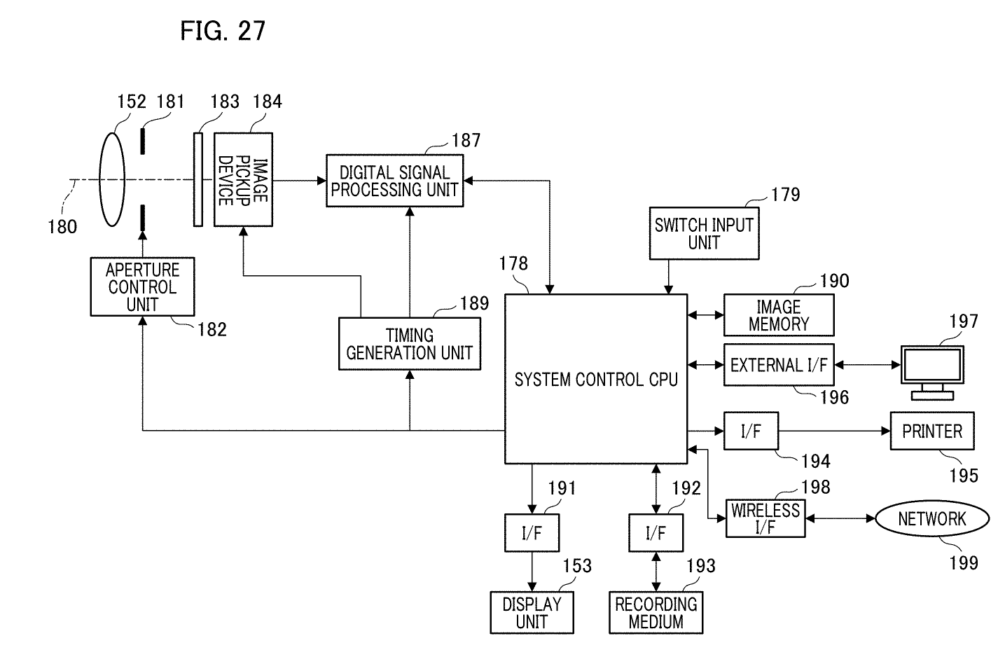

FIG. 27 is a block diagram showing a schematic configuration of an imaging apparatus of the present invention. In FIG. 27, 184 indicates an image element that converts an optical image of a subject formed through the imaging optical system 152 into an electrical image signal. 152 indicates an imaging optical system that forms the optical image of the subject on the image element 184. 180 indicates an optical axis of the imaging optical system 152. 181 indicates an aperture for adjusting an intensity of light that passes through the imaging optical system 152. The aperture 181 is controlled by the aperture control unit 182. 183 indicates an optical filter that limits wavelengths of light that enters the image element 184 and a spatial frequency that is transmitted to the image element 184. The image element 184 has a sufficient number of pixels, a signal reading speed, a color gamut, and a dynamic range which satisfy ultra high definition television standards.

187 indicates a digital signal processing unit configured to perform various types of correction on digital image data output from the image element 184 and then compress image data. 189 indicates a timing generation unit configured to output various timing signals to the image element 184 and the digital signal processing unit 187. 178 indicates a system control CPU configured to control various types of computing and the entire digital still motion camera. The timing generation unit 189 and the system control CPU 178 correspond to a “control device” in the scope of the claims.

190 indicates an image memory configured to temporarily store image data. 191 indicates a display interface unit configured to display a captured image. 153 indicates a display unit such as a liquid crystal display. 193 indicates a removable recording medium such as a semiconductor memory for recording image data, additional data, and the like. 192 indicates a recording interface unit configured to perform recording or reading in or from the recording medium 193. 196 indicates an external interface unit configured to perform communication with the external computer 197 and the like. 195 indicates a printer such as a small ink jet printer. 194 indicates a print interface unit configured to output to and print a captured image on the printer 195. 199 indicates a computer network such as the Internet. 198 indicates a wireless interface unit configured to perform communication via the network 199. 179 indicates a switch input unit that includes the switch ST 154, the switch MV 155, and a plurality of switches for switching between various modes.

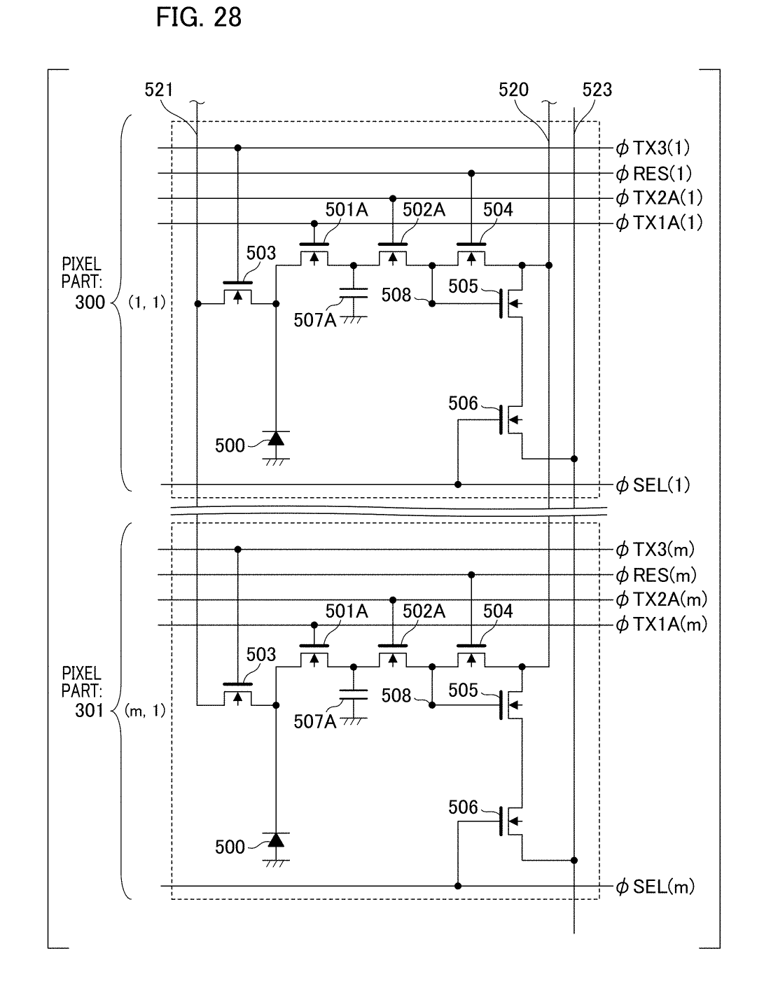

FIG. 28 is a circuit diagram showing a part of the image element 184 in FIG. 27. In FIG. 28, among a plurality of pixels in a matrix form of the image element 184 in FIG. 27, a pixel part 300 of the 1st row and 1st column (1,1) and a pixel part 301 of any m-th row and 1^{st} column (m,1) are shown. Since the configurations of the pixel part 300 and the pixel part 301 are the same, components of the pixel parts 300 and 301 are denoted with the same reference numerals. Here, since a basic structure of the image element 184 including signal holding units is disclosed in, for example, Japanese Patent Laid-Open No. 2010-157893, description thereof will be omitted here.

### <Description of Configuration of Image Element and Image Signal Generation Process>

In the circuit diagram in FIG. 28, one pixel part 300 includes the photodiode 500, the first transfer transistor 501A, the signal holding unit 507A, and the second transfer transistor 502A. The photodiode 500 and the signal holding unit 507A correspond to “photoelectric conversion unit” and “signal holding unit” in the scope of the claims, respectively. In addition, one pixel part 300 includes the third transfer transistor 503, the floating diffusion region 508, the reset transistor 504, the amplifying transistor 505, and the select transistor 506. The image element 184 in which a plurality of pixel parts having the above configuration are two-dimensionally arranged corresponds to “image element” in the scope of the claims.

In addition, the first transfer transistor 501A is controlled by a transfer pulse φTX1A. The second transfer transistor 502A is controlled by a transfer pulse φTX2A. In addition, the reset transistor 504 is controlled by a reset pulse φRES and the select transistor 506 is controlled by a select pulse φSEL. In addition, the third transfer transistor 503 is controlled by a transfer pulse φTX3. Here, control pulses are transmitted from a vertical scanning circuit (not shown). In addition, 520 and 521 are power lines and 523 is a signal output line.

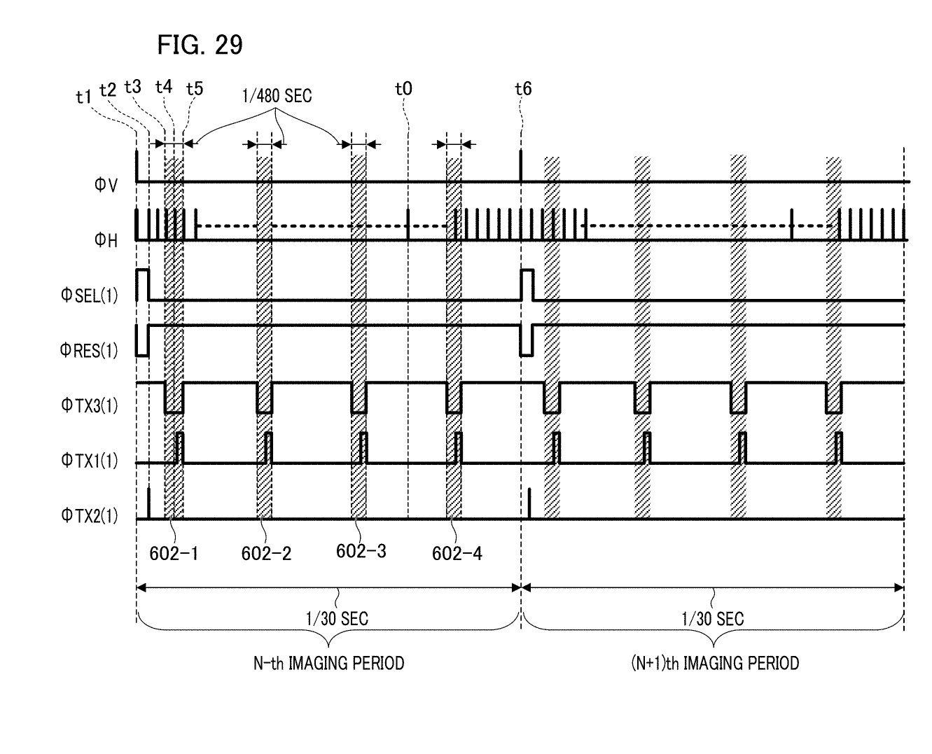

Operations of the image element will be described below in detail with reference to FIG. 29.

FIG. 29 shows timing charts of drive sequences of the image element 184 in FIG. 27. FIG. 29 shows a case in which a moving image is assumed to be captured under a condition of 30 fps, an accumulation for 1/480 sec is added 4 times for 1/30 sec which is one imaging period, and thereby an image signal is obtained.

Here, the image element 184 of the present example includes multiple rows of pixel columns in the vertical direction. FIG. 29 shows timings of the first row. Then, these controls are scanned in the vertical direction by a horizontal synchronization signal, and thus an accumulation operation of all pixels of the image element 184 is performed.

In FIG. 29, rising times t1 and t6 of the vertical synchronization signal φV are vertical synchronization times at which an imaging period starts. 1/30 sec which is a time from t1 to t6 corresponds to “first imaging period” or “second imaging period” in the scope of the claims. In addition, as imaging conditions, during a period of 1/30 sec, four exposures are performed, that is, accumulation of a charge (signal) for 1/480 sec is performed, and these four charges are added, and thereby a moving image is obtained with an exposure amount equivalent to one exposure for 1/120 sec.

First, at the time t1, in the timing generation unit 189, the vertical synchronization signal φV reaches a high level and at the same time, a horizontal synchronization signal φH reaches a high level. In synchronization with the time t1 at which the vertical synchronization signal φV and the horizontal synchronization signal φH become a high level, the reset pulse φRES(1) in the first row reaches a low level. Then, the reset transistor 504 in the first row is turned off, and a reset state of the floating diffusion region 508 is released. At the same time, when a select pulse φSEL(1) in the first row reaches a high level, the select transistor 506 in the first row is turned on, and an image signal in the first row can be read. In addition, an output corresponding to a change in potential of the floating diffusion region 508 is read out to the signal output line 523 through the amplifying transistor 505 and the select transistor 506. A signal read out to the signal output line 523 is supplied to a readout circuit (not shown) and is output to the outside as an image signal in the first row (moving image).

Next, at a time t2, when the transfer pulse φTX2(1) in the first row reaches a high level, the second transfer transistor 502A in the first row is turned on. In this case, since reset pulses φRES(1) in all rows have already become a high level and the reset transistor 504 is turned on, the floating diffusion region 508 in the first row and the first signal holding unit 507A are reset. Here, the select pulse φSEL(1) in the first row at the time t2 reaches a low level.

Next, at a time t3, the transfer pulse φTX3(1) in the first row reaches a low level. Then, the third transfer transistor 503 is turned off, resetting of the photodiode 500 in the first row is released, and accumulation of signal charges of moving images in the photodiode 500 starts. In addition, at the time t4, the transfer pulse φTX1(1) in the first row reaches a high level. Then, the first transfer transistor 501A is turned on, and a signal charge accumulated in the photodiode 500 is transferred to the signal holding unit 507A that maintains charges of moving images in the first row. In addition, at the time t5, the transfer pulse φTX1(1) in the first row reaches a low level. Then, a first transfer transistor 501A is turned off, and transfer of the signal charge accumulated in the photodiode 500 to the signal holding unit 507A ends.

Here, the time t3 to the time t5 corresponds to one accumulation time of 1/480 sec of a moving image in an imaging period and is shown as an accumulation time 602-1 with an area of lines rising diagonally upward. That is, when such an accumulation operation is performed discretely 4 times, this is shown as four accumulation times 602-1, 602-2, 602-3, and 602-4 with an area of lines rising diagonally upward. Then, when signal charges obtained in these four accumulation times 602-1, 602-2, 602-3, and 602-4 are added, a signal amount equivalent to the signal charge obtained for one general accumulation time ( 1/480 sec×4 times= 1/120 sec) is obtained. Here, since control operations in three accumulation times 602-2, 602-3, and 602-4 following the first accumulation time 602-1 are the same as in the first accumulation time 602-1, description thereof will be omitted here.

Next, at the time t6, the vertical synchronization signal φV reaches a high level at the timing generation unit 189 and the horizontal synchronization signal φH reaches a high level at the same time, and the next imaging period starts. Then, the signal charge of the moving image accumulated and added for four accumulation times 602-1, 602-2, 602-3, and 602-4 is output as an image signal (moving image) to the outside after the time t6. Here, a timing chart of the second row is executed in synchronization with a horizontal synchronous vibration φH immediately after the time t1. That is, timing charts in all rows start from the time t1 to the time t6. For example, a timing chart that is started by the horizontal synchronization signal φH at the time t0 is set to the m-th row. In this case, switch signals are represented as φSEL(m), φRES(m), φTX3(m), φTX1A(m), φTX1B(m), φTX2A(m), and φTX2B(m).

According to the timing charts described above, the moving image can be obtained with an exposure amount equivalent to one exposure for 1/120 sec by repeating accumulation of a signal charge according to an exposure for 1/480 sec 4 times in an imaging period of 1/30 sec. Here, an operation of obtaining an image signal by performing exposure and accumulation a plurality of times during one imaging period corresponds to “an operation of generating a first or second image signal by transferring signal charges n times from a photoelectric conversion unit to a signal holding unit in a first or second imaging period” in the scope of the claims. This is provided that, n is a natural number of 2 or more.

Since the moving image obtained in this case is configured by obtaining one image signal by adding short accumulation times set at substantially equal intervals in an imaging period of 1/30 sec, it is possible to obtain a high-quality moving image with no impression of choppiness with frame advance. Here, in the above example, the number of accumulations and additions (the number of separate exposures) of signal charges at general exposure intervals (fps value) is 4. However, the present invention is not limited thereto, and the number may be, for example, 8, 16, 32, or 64.

### <Acquisition of Optical Flow>

In recent years, image elements have become highly functional, and improvements in the number of pixels and a frame rate have been attempted. There is a known method in which vector data (optical flow) indicating a movement of an object between a plurality of images is obtained using this signal. In the present example, the optical flow is acquired from through images. The system control CPU 178 in FIG. 27 generates an optical flow on the basis of comparison between a plurality of images obtained from the image element 184. The system control CPU 178 includes “first and second image signal generation devices, first and second averaging devices, an optical flow candidate calculation device, an approximate optical flow calculation device, and an optical flow estimation device” in the scope of the claims.

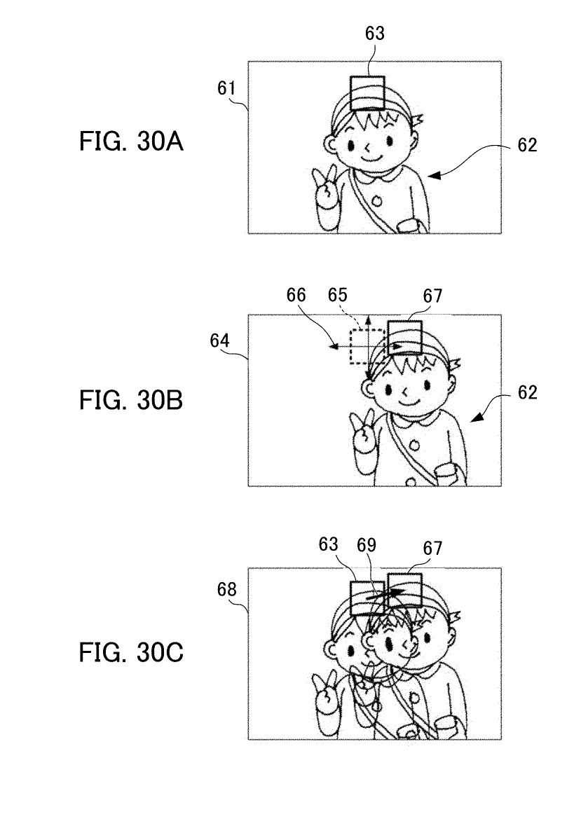

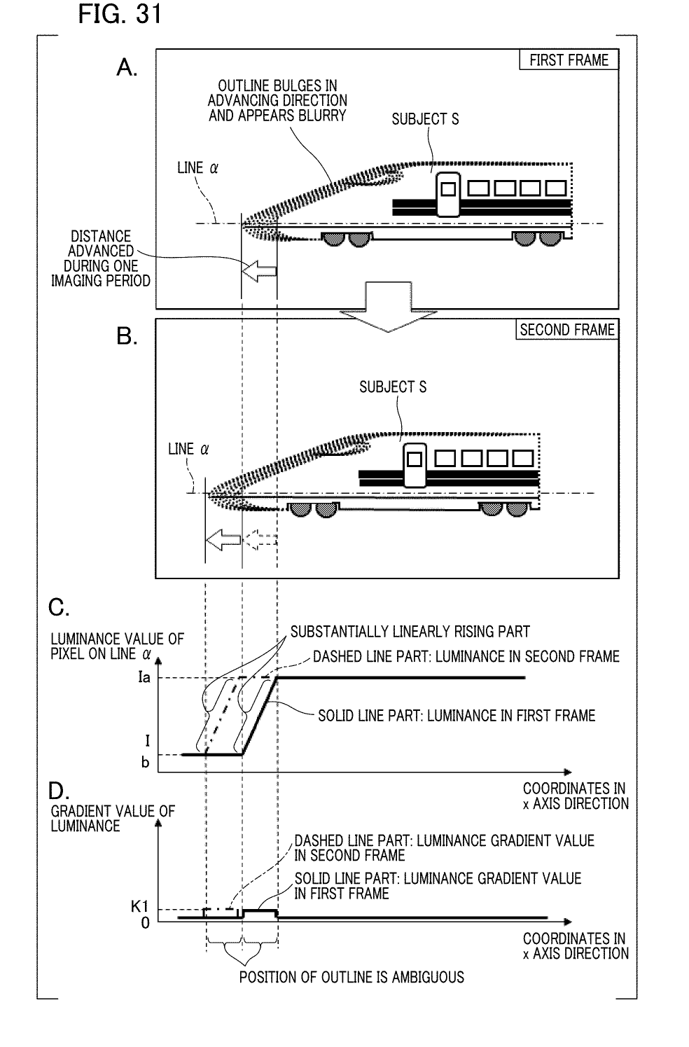

FIG. 30 shows diagrams of an example of a method of obtaining an optical flow which is a blur detection signal based on comparisons between a plurality of images, which corresponds to specific operations of the system control CPU 178 in FIG. 27. FIG. 30 is based on a so-called block matching method, but other methods may be used. FIG. 30A shows an image that is acquired at the time tₙ and FIG. 30B shows an image that is acquired at the time tₙ₊₁ after the time tₙ. In addition, FIG. 30C shows the image acquired at the time tₙ and the image acquired at the time tₙ₊₁ in an overlapping manner and additionally, schematically displays a detected vector.

In FIG. 30, 61 indicates the image acquired at the time tₙ, 62 indicates a subject, and 63 indicates a region of interest in the image 61. In addition, 64 indicates the image acquired at the time tₙ₊₁. 65 indicates an area having the same position in the screen as the region of interest 63. 66 indicates an arrow that schematically shows searching. 67 indicates an area in the image 64 corresponding to the region of interest 63 of the subject 62 in the image 61. In addition, 68 indicates an image in which the images acquired at the time tₙ and the time tₙ₊₁ are displayed in an overlapping manner, and 69 indicates a movement vector that is detected in the region of interest 63 in the image 61.

First, as shown in FIG. 30, two images 61 and 64 acquired at different times are prepared. The region of interest 63 in which the subject 62 is present in one image 61 between the two images is focused upon. A size of the region of interest 63 can be arbitrarily set, and can be, for example, 8×8 pixels. Then, a position in the image 64 to which the region of interest 63 has moved is found by comparing feature points and the like.

Specifically, in the image 64, feature points such as edges and corners in the image 64 are extracted while the area 65 is gradually shifted as indicated by the arrow 66 in a predetermined range with the area 65 corresponding to the region of interest 63 as the center. In addition, feature values are computed from the surrounding area to perform matching between the two images 61 and 64. Feature points such as edges and corners are extracted such that luminance gradient values of luminance data in the horizontal direction and vertical direction are computed, and a part in which the gradient value is a constant value or more in each of the directions is extracted.

As a result, it can be seen that, in the image 68, the region of interest 63 is moved like the vector 69. Then, the above operation is performed on a plurality of regions of interest set in the image 61. In this case, a plurality of movement vectors are detected in the image 68. Then, vector selection is performed focusing on the subject 62. For example, an estimated value may be obtained using random sample consensus (RANSAC), and one evaluation value of the movement vector can be determined. Here, since there is a known technology regarding RANSAC, details thereof will be omitted here. At this time, in an imaging method in the related art, when the outline of the image between frames to be compared becomes unclear due to a movement of an object, hand shake, or the like, there is a problem that a precise optical flow is not obtained.

<Problems when an Optical Flow is Acquired by Extracting Feature Points>

Hereinafter, problems when an optical flow is acquired will be described using a schematic diagram of an image obtained when a scene in which a subject passes by in the horizontal left direction of a screen is captured by different exposure methods.

FIG. 31A, FIG. 31B, FIG. 31C, and FIG. 31D show a first comparative example, and show an example in which a scene in which a subject S (Shinkansen as an example) crosses a screen in the horizontal direction is captured as a moving image at 30 fps and an exposure time of 1/30 sec for one frame.

FIG. 31A is a diagram in which one frame in the captured moving image is extracted and FIG. 31B is a diagram in which one frame after the one frame in FIG. 31A is extracted. Hereinafter, the one frame in FIG. 31A will be referred to as a first frame and the one frame in FIG. 31B will be referred to as a second frame. At this time, in both diagrams, it can be seen that the outline of the subject S is blurred by an amount of movement for 1/30 sec which is an exposure time because the subject S to be imaged moves at a high speed.

Here, a case in which feature values are computed from the outlines of both the images of the subject S in the first frame and the second frame which is the next frame shown in FIG. 31A and FIG. 31B described above and they are compared is considered. In general, when feature values are compared, first, an outline part (edge part) is extracted. As a method used for extracting an outline part (edge), a method in which luminance values I (x,y) of pixels are spatially distributed in a specific direction, and gradient values K (x,y) of the luminance I (x,y) in the direction are obtained is generally used.

In FIG. 31A and FIG. 31B, in order to simplify explanation, a case in which luminance values are spatially distributed in the horizontal direction (x direction) is considered. In addition, focusing only on pixels in a row of the shown line α, luminance will be discussed.

In this case, when a luminance value in a pixel in the X-th column on the line α is set as I(X), a gradient value K(x) is represented by the following formula (1).

K(x)=dI(X)/dx (1)

FIG. 31C is a graph showing the relationship between a position in the x direction of a pixel in a row of the shown line α (a pixel in a column in the x direction) and the luminance I(x).

In FIG. 31C, a solid line part indicates a luminance value of a pixel on the line α in the first frame, and a dashed line part indicates a luminance value of a pixel on the line α in the second frame. In addition, a luminance value Ia on the vertical axis indicates a luminance value of the body of the subject S (Shinkansen) and a luminance value Ib on the vertical axis indicates a luminance value of the background. Here, in the present example, Ia>Ib is established.

When the subject S moves at a substantially uniform speed, a part in which the outline is blurred because the subject S in FIG. 31A and FIG. 31B moves during an exposure corresponds to a graph in which a corresponding part in the graph of the luminance value I(x) in FIG. 31C rises substantially linearly.

FIG. 31D is a graph showing the relationship between a position in the x direction of a pixel in a row of the line α and a gradient value K(x) of a luminance. As in the case of the luminance graph, a solid line part indicates a gradient value of a luminance of a pixel on the line α in the first frame and a dashed line part indicates a gradient value of a luminance of a pixel on the line α in the second frame.

With reference to the luminance value in FIG. 31C, a luminance value of the part in which the outline is blurred in FIG. 31A and FIG. 31B described above has a linear form that rises substantially constantly. Therefore, a gradient value of the luminance value in FIG. 31D has a substantially constant value indicated by the value of K1 in a part in which the outline is blurred. Here, generally, a pixel having a gradient value that is a predetermined value or greater is determined as a pixel expressing the outline (position). However, if the outline is blurred as in the present example, as can be clearly understood from FIG. 31D, a part in which the gradient value (differential value) is equal to or larger than a certain value spans a wide range. Therefore, it is not possible to precisely determine the outline position in the first frame and the outline position in the second frame, and as a result, a problem that it is not possible to precisely obtain a movement amount of the subject S occurs.

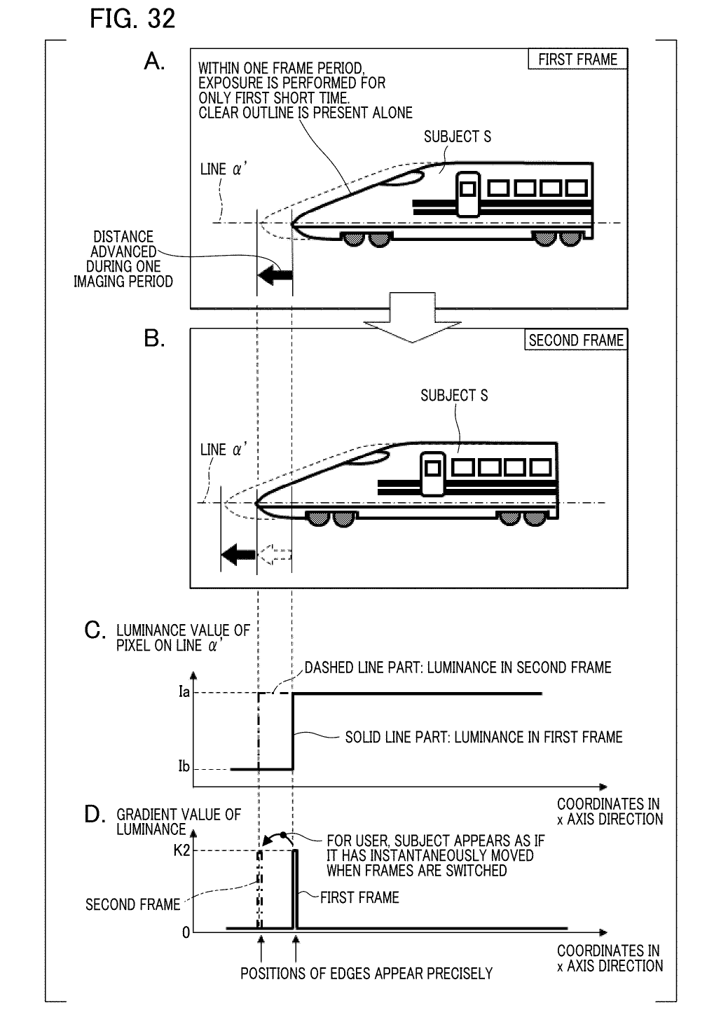

FIG. 32A, FIG. 32B, FIG. 32C, and FIG. 32D show a second comparative example and show an example in which a method of obtaining a sharp outline by simply shortening an exposure time for one frame is performed in order to address the above problem. An example in which a scene in which the subject S crosses a screen in the horizontal direction is captured as a moving image at 30 fps and an exposure time of 1/30 sec for one frame as imaging conditions is shown.

FIG. 32A is a diagram in which one frame in the captured moving image is extracted and FIG. 32B is a diagram in which one frame after the one frame in FIG. 32A is extracted. As can be understood from FIG. 32A and FIG. 32B, an exposure and transfer are performed only for a short time ( 1/480 sec) immediately after start in each frame for 1/30 sec, and signal charges are accumulated. Therefore, compared to the above first comparative example, an image in which an amount of movement of the subject S during an exposure time becomes smaller and the outline is sharp is obtained.

FIG. 32C is a graph showing the relationship between a position in the x direction of a pixel in a row of a line α′ (a pixel in a column in the x direction) and the luminance I(x). In FIG. 32C, a solid line part indicates a luminance value of a pixel on the line α′ in the first frame and a dashed line part indicates a luminance value of a pixel on the line α′ in the second frame. In addition, a luminance value Ia on the vertical axis indicates a luminance value of the body of the subject S (Shinkansen) and a luminance value Ib on the vertical axis indicates a luminance of the background. Here, in the present example, Ia>Ib is established.

In this case, the sharp outline part of the subject S in FIG. 32A and FIG. 32B corresponds to a graph in which a corresponding part rises sharply in the graph of the luminance value I(x) in FIG. 32C.

FIG. 32D is a graph showing the relationship between a position in the x direction of a pixel in a row of the line α′ and the gradient value K(x) of the luminance. As in the case of the luminance graph, a solid line part indicates a gradient value of a luminance of a pixel on the line α′ in the first frame and a dashed line part indicates a gradient value of a luminance of a pixel on the line α′ in the second frame.

A sharp outline part in FIG. 32A and FIG. 32B described above has a graph form that rises sharply in the luminance value in FIG. 32C. That is, it can be understood that a gradient value of the luminance in FIG. 32D increases locally to a large gradient value (denoted as K2) in a very narrow x axis area part. In this case, since a part in which a luminance gradient value is equal to or larger than a certain value is a very narrow area, it is possible to precisely obtain the outline position in the x axis direction. Therefore, it is possible to precisely calculate the optical flow. However, in this method, the optical flow is precisely obtained, but there is a problem of quality of the moving image.

As described above, since exposure, transfer, and accumulation are performed only for the first short time ( 1/480 sec) in each frame, during the remaining time of 1/30 sec for one frame after the exposure, transfer, and accumulation are completed, no image is captured. A time at which capturing of the next image starts is a starting point of the second frame, and the subject continues to move in an advancing direction during that time. As shown in FIG. 32A and FIG. 32B, a position of the subject S when the second frame starts and an exposure starts is a position that is greatly moved from a position of the subject S in the image captured in the first frame. As a result, as shown in the graph of the gradient value in FIG. 32D, the distance from a raising part of the graph showing the outline of the subject S in the first frame to a raising part showing the outline of the subject S in the second frame is increased. For a user who views a moving image, when the first frame is moved to the second frame, the subject S appears as if it has instantaneously moved that distance and, and this causes the above impression of choppiness to be experienced, and quality of the moving image deteriorates.

On the other hand, in the above example in which the outline is blurred in FIG. 31, in the graph of the gradient value in FIG. 31D, a distance between the left end of the raising part of the graph showing the blurred outline in the first frame and the right end of the raising part of the graph showing the blurred outline in the second frame is not substantially increased. In this case, for a user who views a moving image, when frame changes to frame, since positions of the outlines of preceding and following frames are substantially continuous, they appear to be changing smoothly with no impression of choppiness. Therefore, since the outline is blurred, it is not possible to precisely calculate the optical flow, but the moving image has high quality with no impression of choppiness.

As described above, as shown in the example in FIG. 31, when an exposure is performed only for substantially the same time of 1/30 sec with respect to an imaging period time of one frame, the outline of the object that moves is blurred and it is not possible to precisely calculate the optical flow. However, the moving image smoothly changes and has high quality with no impression of choppiness. On the other hand, as shown in the example in FIG. 32, when an exposure is performed only for a short time of 1/480 sec with respect to an imaging period time of one frame, a sharp outline is obtained even if an object is moving, and it is possible to precisely calculate the optical flow. However, it can be understood that the moving image has low quality in which an impression of choppiness is experienced.

As described above, in the first and second comparative examples, it is not possible to achieve both precise calculation of the optical flow and capturing a high-quality moving image with no impression of choppiness.

### <Calculation of Optical Flow Using Separate Exposure>

On the other hand, in the present invention, an optical flow is estimated using a method of acquiring a moving image by performing exposure, transfer, and accumulation a plurality of times for 1/30 sec for one frame in a divided manner so that the problem is addressed. Descriptions thereof are as follows.

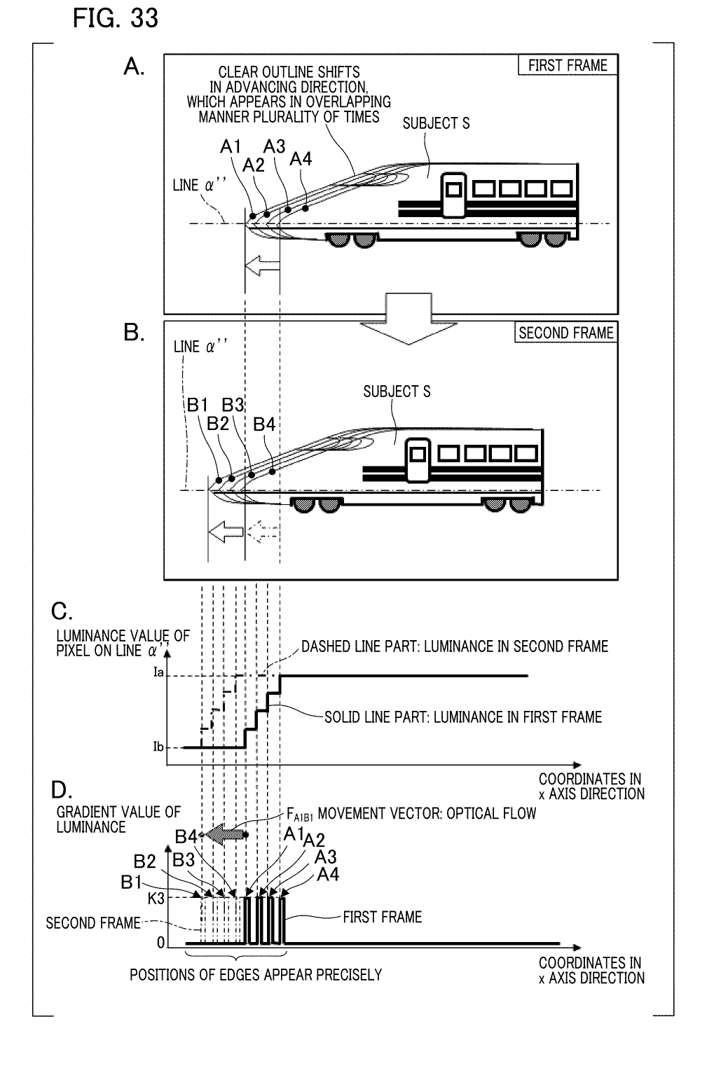

FIG. 33 shows images acquired when a scene in which the subject S crosses a screen in the horizontal direction is captured as a moving image at 30 fps, in an imaging period of 1/30 sec for one frame, and an exposure is divided among 4 times of 1/480 sec each according to the configuration of the present example.

FIG. 33A is a diagram in which one frame in the captured moving image is extracted, and FIG. 33B is a diagram in which a frame after the one frame is extracted. As shown in FIG. 33A and FIG. 33B, since the subject S is exposed 4 times, while movement amounts of about ¼ over 1/30 sec overlap in the advancing direction, four sharp outlines are shown in A1 to A4 in the first frame and B1 to B4 in the second frame.

FIG. 33C is a graph showing the relationship between a position in the x direction of a pixel in a row of the shown line α″ (a pixel in a column in the x direction) and the luminance I(x). In FIG. 33C, a solid line part indicates a luminance value of a pixel on the line α″ in the first frame and a dashed line part indicates a luminance value of a pixel on the line α″ in the second frame. In addition, a luminance Ia on the vertical axis indicates a luminance of the body of the subject S (Shinkansen) and Ib indicates a luminance of the background. In the present example, Ia>Ib is established.

In this case, in FIG. 33A and FIG. 33B, the four sharp outline parts of the subject S that overlap each other while shifting correspond to a staircase graph in which corresponding parts rise sharply in the graph of the luminance value I(x) in FIG. 33C.

In addition, FIG. 33D is a graph showing the relationship between a position in the x direction of a pixel in a row of the shown line α″ and a gradient value K(x) of a luminance. As in the case of the luminance graph, a solid line part indicates a gradient value of a luminance of a pixel on the line α″ in the first frame and a dashed line part indicates a gradient value of a luminance of a pixel on the line α″ in the second frame.

In FIG. 33A and FIG. 33B described above, the four sharp outline parts that overlap each other while shifting correspond to parts that rise sharply in the staircase graph in the luminance value in FIG. 33C. Therefore, it can be understood that a gradient value of the luminance in FIG. 33D increases locally to a large gradient value (denoted as K3) only in an area in which the part is very narrow in the x axis and there are four of these parts in each of the first frame and the second frame. In this case, since the part having a luminance gradient value that is a certain value or greater is a very narrow area, it is possible to precisely obtain positions of four outlines in the x axis direction in the frames.

Therefore, if the outline in the second frame corresponding to the outline of interest in the first frame can be accurately selected, since it is possible to precisely obtain positions of the outlines, it is possible to precisely obtain an optical flow which is a movement vector thereof. In FIG. 33D, for example, the optical flow is obtained as the shown vector F_{A1B1} which is a movement vector from the left end edge A1 in the first frame to the corresponding left end edge B1 in the second frame.

Here, an operation of obtaining an image in which a plurality of sharp outlines overlap each other corresponds to “an operation of generating a first or second image signal by transferring signal charges n times from a photoelectric conversion unit to a signal holding unit in a first or second imaging period” in the scope of the claims.

In addition, in the present example, as described above, exposure is performed a plurality of times although it is performed for a short time during an imaging period of 1/30 sec. Therefore, as shown, an interval between the end of the raising part indicating the outlines A1 to A4 in the graph of the first frame indicated by a solid line and the end of the raising part indicating the outlines B1 to B4 in the graph of the second frame indicated by a dashed line is controlled such that it becomes smaller. Therefore, for a user who views a moving image, the outline of the subject S in the first frame and the outline of the subject S in the second frame appear substantially continuous, and a high-quality moving image with no impression of choppiness is obtained.

### <Selection of Appropriate Outline by Gradual Narrowing Down>

However, in the above method, like A1 to A4 indicating the outlines of the subject S in the first frame and the edges B1 to B4 indicating the outlines of the subject S in the second frame, edges with the same shape are arranged at uniform intervals. In this case, there is a risk of the same edge corresponding to the edge in the first frame being erroneously selected from the second frame. That is, this is because, in the case of the present example, like Japanese Patent Laid-Open No. 2010-157893, since outlines with the same shape are arranged with the same intervals therebetween, in comparison to detecting feature points with limited blocks, a corresponding part may be erroneously recognized.

Specifically, in FIG. 33D, if the edge corresponding to the edge A1 is erroneously recognized as the edge B2 with the same shape rather than B1, although there is actually a movement from A1 to B1, this is recognized as a movement from A1 to B2, and a situation in which a movement amount is reduced from a real value may occur. Therefore, a method for extracting an appropriate edge from an edge group overlapping while shifting in the movement direction is required.

In order to address the above problem, as will be described below, the present invention performs a two-stage narrowing down procedure in estimation of the optical flow.

That is, after images of the first frame and the next second frame are obtained, as a first procedure, low pass filter processing in which a predetermined number of adjacent pixels in a predetermined direction (such as the horizontal direction and the vertical direction) of the image and luminance values are averaged with respect to the image luminance value and a high frequency component is removed is performed.

For example, an example in which luminance values in the horizontal direction are averaged will be described as follows.

When a luminance value of a pixel in the x-th column of original data is set as I₁(x), the luminance value I₂(x) obtained after low pass filter processing is performed is calculated by performing a process of averaging a predetermined number of preceding and following pixels. For example, in the case of averaging three preceding and three following pixels, the luminance value I₂(x) is an average of luminances I₁(x) in a total of 7 pixels including three pixels in front of a pixel of interest, three pixels behind the pixel of interest and the one pixel of interest itself, and is represented by the following Formula (2).

I₂(x)=I₁(x−3)+I₁(x−2)+I₁(x−1)+I₁(x)+I₁(x+1)+I₁(x+2)+I₁(x+3)/(3+3+1) (2)

Here, while an average of a total of 7 pixel signals including three preceding and three following pixel signals has been described in the present example, the present invention is not limited to this number of pixels. As long as a method of performing low pass filter processing using an average of a plurality of adjacent pixel signals is used, the present invention can be applied to a case using any number of pixel signals.

The operation corresponds to “operation of generating a third or fourth image signal by averaging luminance values of pixel parts with luminance values of a predetermined number of adjacent other pixel parts with respect to a generated first or second image signal” in the scope of the claims. In addition, a device that can remove a high frequency component with a low pass filter corresponds to “first or second averaging device” in the scope of the claims.

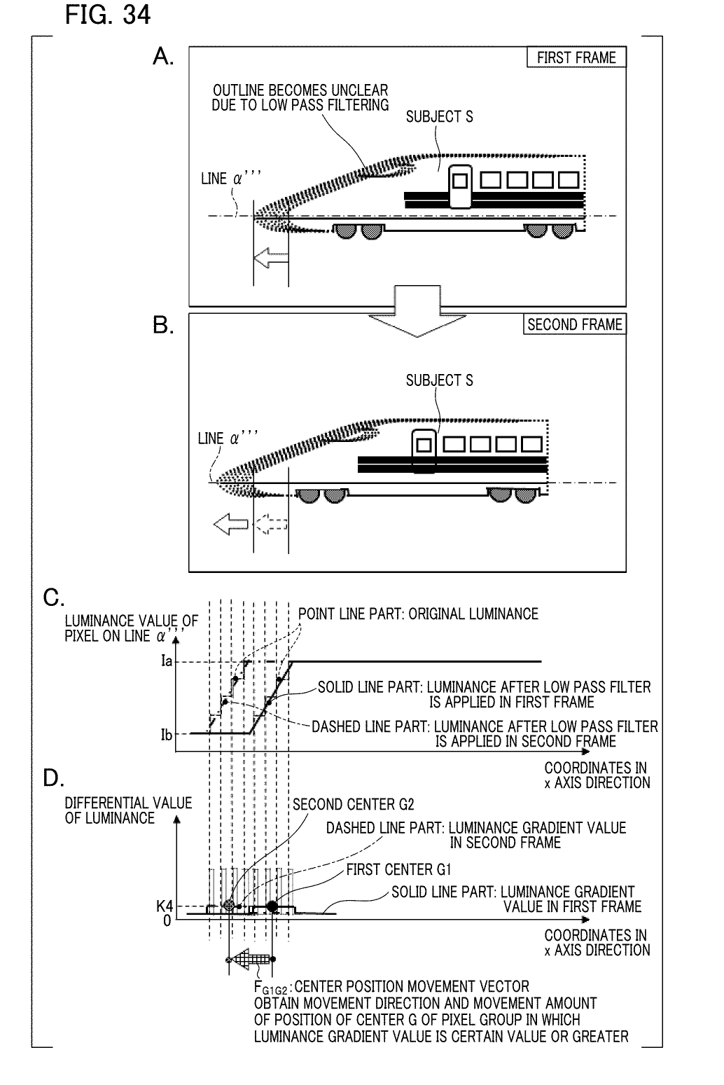

FIG. 34A and FIG. 34B show examples of images of luminance data I₂(x) (third and fourth image signals) obtained by performing low pass filter processing on the luminance data I₁(x) (first and second image signals) of the moving image obtained by the separate exposure in FIG. 33. According to such drawings, a high frequency component is removed and luminance data I₂(x) in which the outline of the image is blurred is obtained. Here, while simple averaging is performed in the present example, the present invention is not limited thereto. Weighted averaging in which luminance values of pixels are multiplied by a weighting factor may be performed, and a high frequency component removing process using averaging can be applied to the present invention.

Here, the operation of obtaining a luminance I₂(x) corresponds to “operation of generating a third or fourth image signal by averaging luminance values of pixel parts with luminance values of a predetermined number of adjacent other pixel parts” in the scope of the claims.

FIG. 34C is a graph showing the relationship between a position in the x direction of a pixel in a row of the shown line α′″ (a pixel in a column in the x direction) and the luminance I(x). In FIG. 33C, a solid line part indicates a luminance value of a pixel on the line α′″ in the first frame and a dashed line part indicates a luminance value of a pixel on the line α′″ in the second frame. In addition, a luminance Ia on the vertical axis indicates a luminance of the body of the subject S (Shinkansen) and Ib indicates a luminance of the background. In the present example, Ia>Ib is established.

Parts in which the outline is blurred by low pass filter processing in FIG. 34A and FIG. 34B are as follows in the luminance graph in FIG. 34C. That is, as can be clearly understood from FIG. 34C, corresponding outline parts change from a staircase form indicated by a dotted line before the low pass filter processing to a graph that rises substantially linearly and is indicated by a solid line and a dashed line.

FIG. 34D is a graph showing the relationship between a position in the x direction of a pixel in a row of the shown line α′″ and a gradient value K₂(x) of a luminance. As in the case of the luminance graph, a solid line part indicates a gradient value of a luminance of a pixel on the line α′″ in the first frame and a dashed line part indicates a gradient value of a luminance of a pixel on the line α′″ in the second frame.

In this case, as shown in FIG. 34D, a part having a differential value that is a certain value or greater is present in a wide range at positions in the x axis direction. Therefore, it is not possible to measure a precise position. Here, a pixel group in which a gradient value of data of the luminance I₂(x) in the horizontal direction (x direction) is a predetermined value or greater is extracted and a center position thereof is obtained. A center position of a pixel group having a gradient value that is a certain value or greater in the first frame is set as G1, and similarly, a center position of a pixel group having a gradient value that is a certain value or greater in the second frame is set as G2.

The center position (first center) G1 in the first frame and the center position (second center) G2 in the second frame are obtained, and an approximate optical flow F_{G1G2} is then obtained by a block matching method. The approximate optical flow F_{G1G2} indicates a movement direction and a movement amount of the corresponding center position in the first frame and the second frame. The approximate optical flow F_{G1G2} is an optical flow obtained when the image outline is unclear due to low pass filtering as in the case of FIG. 31 and shows an approximate movement amount and direction, and it is not possible to precisely estimate the outline position therewith.

However, to summarize the present invention, by combining both this rough movement vector and a plurality of sharp outline parts obtained by performing an exposure a plurality of times in the above one imaging period, and performing block matching performed once again, a precise outline position is thereby obtained.

That is, after the approximate optical flow F_{G1G2} is obtained, as the next procedure, the procedure returns to data of the luminance I₁(x) before the low pass filter in FIG. 33A to FIG. 33D is applied based on the result. Then, an operation of specifying positions of the edges A1 to A4 and B1 to B4 of the image showing a clear outline is performed.

Here, a gradient value of the luminance shown in FIG. 33D is focused on again. In general, in block matching in which it is determined whether feature points partially match, if outlines with the same shape are arranged at uniform intervals in this manner, since matching feature points are present, for example, it is not possible to determine which of B1 to B4 in the second frame is the edge corresponding to the edge A1 in the first frame. Therefore, a plurality of optical flows in which feature points match, of a number which at a maximum is the same number as that of edges, are detected, and it is not possible to determine which is a correct optical flow in this case. A group of a plurality of detected optical flows will be described as optical flow candidates below. However, since the optical flow candidates are based on a sharply displayed outline, if an optical flow candidate is correctly selected using the approximate optical flow F_{G1G2}, as a result, it is possible to obtain a precise optical flow.

That is, as described above, in the procedure of the present invention, the approximate optical flow F_{G1G2} which is a rough movement vector is obtained according to data of the luminance I2(x) to which the low pass filter is applied in advance. Therefore, it is possible to speculate that there is an edge corresponding to the edge A1 in the second frame near a point that has deviated from the edge A1 by the approximate optical flow F_{G1G2}. Therefore, block matching is started using a point that has deviated from the edge A1 by the approximate optical flow F_{G1G2} as a starting point, and an outline at a position closest to the starting point among outlines in which feature points match is determined as a corresponding edge, and thus it is possible to improve detection accuracy.

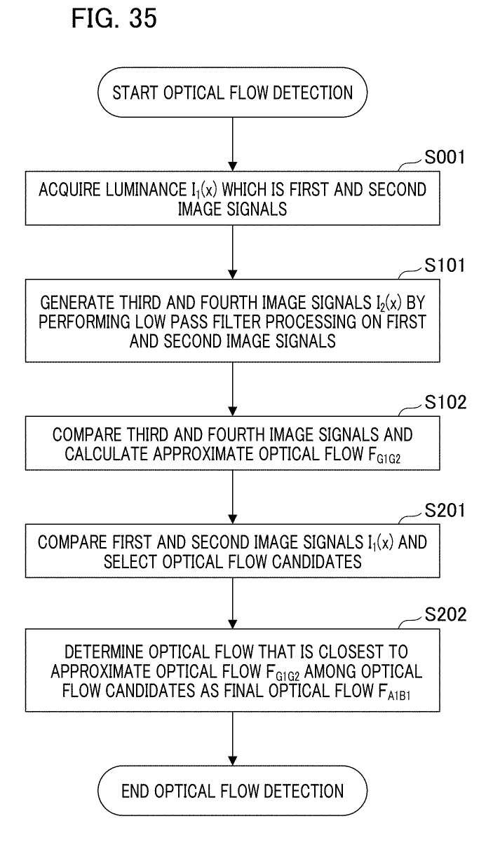

FIG. 35 is a flowchart of the optical flow estimation procedure.

When the flow starts, first, in Step S001, exposure, transfer, and accumulation are performed a plurality of times during one imaging period and thereby a moving image is acquired. That is, a luminance I₁(x) which is a first image signal is acquired in a first imaging period (the first frame) and a luminance I₁(x) which is a second image signal is acquired in a second imaging period (the second frame). Next, in Step S101, the low pass filter processing according to averaging with a predetermined number of adjacent pixel signals is performed on the first and second image signals obtained in the previous step and third and fourth image signals (data of the luminance I₂(x)) are generated.

Then, in Step S102, the third and fourth image signals generated in the previous step are compared and an approximate optical flow F_{G1G2} which is a rough optical flow is calculated. In addition, in Step S201, the first and second image signals I₁(x) obtained in Step S001 are compared and the above optical flow candidate is selected. Here, regarding the first and second image signals, since a plurality of same outlines are arranged with the same intervals therebetween, when feature points are compared, there are a plurality of optical flow candidates in which features match.

Finally, in Step S202, from among the plurality of optical flow candidates selected in the previous step, an optical flow that is closest to the approximate optical flow F_{G1G2} obtained in Step S102 is selected as a final optical flow.

Thus, it is possible to estimate the final optical flow with high accuracy and the flow of the optical flow estimation procedure ends.

Here, the above optical flow estimation procedure is performed by the “optical flow candidate calculation device, approximate optical flow calculation device, and optical flow estimation device” in the scope of the claims.

In addition, an operation of selecting an optical flow candidate corresponds to “operation of calculating a plurality of optical flow candidates which are vectors indicating a movement direction and amount of a subject during first and second imaging periods” in the scope of the claims. In addition, an operation of obtaining an approximate optical flow F_{G1G2} corresponds to “operation of calculating an approximate optical flow which is a vector indicating an approximate movement direction and amount of a subject during first and second imaging periods” in the scope of the claims. In addition, an operation of obtaining a real optical flow corresponds to “operation of estimating one optical flow candidate that is closest to an approximate optical flow among a plurality of optical flow candidates as a final optical flow” in the scope of the claims.

As described above, in the present invention, as the first procedure, a movement vector with low accuracy is obtained from low-pass filtered image data. In addition, as the second procedure, a precise movement vector is narrowed down from the original image data based on the movement vector. The present invention performs such two-stage narrowing down. According to such a procedure, it is possible to accurately select a corresponding edge when the first frame transitions to the second frame from among a plurality of edges that appear in the image according to a separate exposure, and even if a separate exposure is used, it is possible to precisely estimate a real optical flow F_{A1B1}.

### <Nonuniform Division Interval>

Accuracy of selection of a corresponding outline between the preceding and following frames can be improved using the following method.

In FIG. 29 described above, time intervals between exposure timings 602-1, 602-2, 602-3, and 602-4 are equal when exposure is performed 4 times during one imaging period. As a result, as shown in FIG. 33A to FIG. 33D, an image in which the outlines of the subject S are shifted by a uniform width in the advancing direction and overlap each other is obtained. Since the outlines with the same shape are shifted by a uniform width, a plurality of candidates may be obtained for a part in which feature points are the same. Accordingly, there is a risk of erroneously selecting an outline.

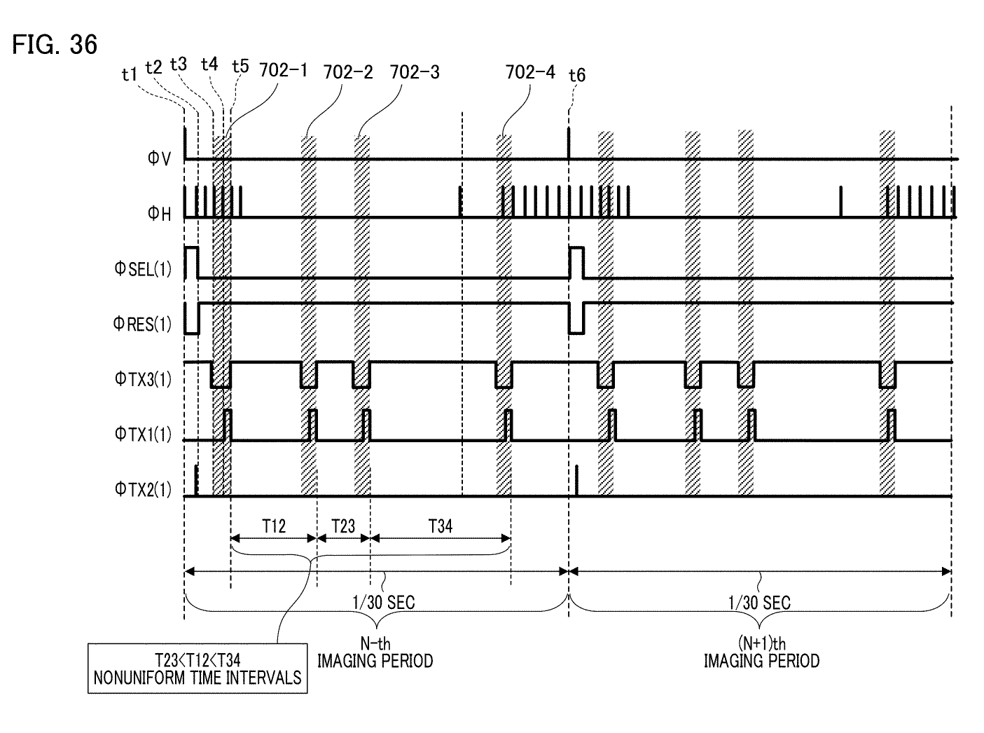

Here, as shown in FIG. 36, when exposure is performed 4 times during one imaging period, time intervals T12, T23, and T34 between exposure timings 702-1, 702-2, 702-3, and 702-4 may be set to be nonuniform intervals instead of uniform intervals. While T23<T12<T34 is established in the present example, the present invention is not limited thereto. At least two of these time intervals may be time intervals different from each other.

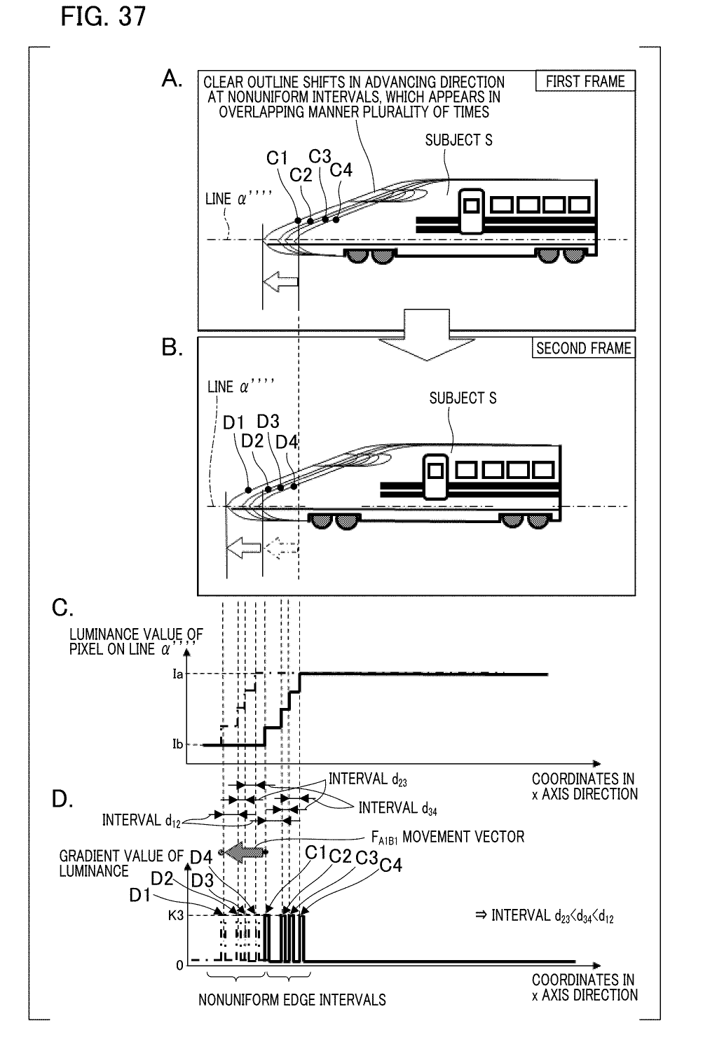

The images obtained in the present example are shown in FIG. 37A and FIG. 37B. If the shown subject S moves at a uniform speed, the outline of the subject S corresponds to an image in which four outlines are arranged at nonuniform intervals while shifting in the advancing direction as in C1 to C4, and D1 to D4.

FIG. 37C is a graph showing the relationship between a position in the x direction of a pixel in a row of the shown line α″″ (a pixel in a column in the x direction) and the luminance I(x). In FIG. 37C, a solid line part indicates a luminance value of a pixel on the line α″″ in the first frame and a dashed line part indicates a luminance value of a pixel on the line α″″ in the second frame.

In this case, the outline parts of the subject S in FIG. 37A and FIG. 37B correspond to four sharp outline parts that overlap each other while shifting at nonuniform intervals. That is, in the graph of the luminance value I(x) in FIG. 37C, a staircase graph in which corresponding parts rise sharply at nonuniform intervals is obtained.

In addition, FIG. 37D is a graph showing the relationship between a position in the x direction of a pixel in a row of the shown line α″″ and a gradient value K(x) of a luminance. As in the case of the luminance graph, a solid line part indicates a gradient value of a luminance of a pixel on the line α″″ in the first frame and a dashed line part indicates a gradient value indicates a luminance of a pixel on the line α″″ in the second frame.

In FIG. 37A and FIG. 37B, in four sharp outline parts that overlap each other while shifting nonuniformly, in the luminance gradient value in FIG. 37D, the four parts are shifted nonuniformly in the x axis direction. In addition, the outline part increases locally to a large gradient value (denoted as K3) only in a very narrow x axis area. In addition, it can be understood that this part is present in each of the first frame and the second frame.

In this case, since a part having a luminance gradient value that is a certain value or greater is a very narrow area, it is possible to precisely obtain positions of four outlines that are arranged at nonuniform intervals in the frames in the x axis direction. Here, unlike the case in FIG. 33D, the fact that intervals d12, d23, and d34 between edges C1 to C2, C2 to C3, and C3 to C4 have different values even if outlines have the same shape is focused on for the gist of the present invention. This similarly applies to intervals between edges D1 to D2, D2 to D3, and D3 to D4. In this case, due to nonuniform arrangement, there is a difference in relative distances between feature points of the outlines, which makes it possible to distinguish which edge is the edge. Therefore, a corresponding edge is not erroneously selected in block matching using the configuration. Therefore, even if exposure, transfer, and accumulation are performed a plurality of times in one imaging period, it is possible to precisely estimate the optical flow rather than erroneously estimating it.

In addition, since exposure is performed a plurality of times at nonuniform intervals, in the graph of the gradient value in FIG. 37D, intervals between the left end of the raising parts C1 to C4 showing the outline of the subject S in the first frame and the right end of the raising parts D1 to D4 showing the outline in the second frame is controlled such that it becomes smaller. Therefore, for a user who views a moving image, the outline of Shinkansen in the first frame and the outline of the subject S in the second frame appear substantially continuous, and a high-quality moving image with no impression of choppiness is obtained.

As described above, when a plurality of exposure timings are set at nonuniform time intervals in one imaging period, it is possible to implement a configuration that can acquire a high-quality moving image while a precise optical flow is calculated. In addition, the plurality of exposure timings that are set at nonuniform time intervals corresponds to “in each of first and second imaging periods, n times of signal charge transfer are performed such that time intervals between n transfer timings at which transfer starts are different from each other” in the scope of the claims.

### <Time Interval Between Signal Charge Transfer Timings>

It is desirable to set the number of times of exposure, transfer, and accumulation so that a time interval between signal charge transfer timings, that is, a time interval between a plurality of exposure timings in FIG. 29 is 1/120 sec or shorter. This is because it is difficult to read a change within the time of a general human reflex speed of 1/120 sec or shorter, and when a time interval equal to or shorter than that time is set, an impression of choppiness is not noticeable and it is possible to provide a high-quality moving image.

Therefore, as an example, when an exposure time for one frame is 1/30 sec for moving image capturing, an exposure that is divided among at least 4 times within one frame is performed and time intervals between four exposures is set to 1/120 sec or shorter. In addition, when an exposure time for one frame is 1/60 sec, an exposure is divided among at least twice and an time interval between two exposures is set to 1/120 sec or shorter.

According to the above configuration, it is possible to implement a configuration that can optimize the number of times of exposure and acquire a high-quality moving image with no impression of choppiness.

Here, an operation of setting the number of times of exposure so that the time interval becomes 1/120 sec or shorter corresponds to “operation of increasing and decreasing a value of n so that time intervals between n transfer timings at which n times of signal charge transfer start are 1/120 sec or shorter” in the scope of the claims.

### Modified Examples

In the above imaging apparatus, the system control CPU (control device) 178 in FIG. 27 may include a moving body determination device configured to determine whether a subject is a moving body during capturing a moving image. In this case, when it is determined that a subject is a moving body by the moving body determination device, the optical flow estimation procedure shown in FIG. 35 is performed. Thereby, it is possible to obtain an optical flow with high accuracy when a moving image is captured.

In addition, the system control CPU (control device) 178 in FIG. 27 may include a speed determination device configured to determine a speed of a subject (moving body) or a hand movement speed during capturing a moving image. In this case, when the speed determination device determines that a speed of a subject or a hand movement speed is a predetermined value or greater, the optical flow estimation procedure shown in FIG. 35 is performed. In addition, the system control CPU 178 makes an association between the speed of the subject or the hand movement speed detected by the speed determination device and the number of times of signal charge transfer during one imaging period or a time interval between transfer timings. This association is stored in a look up table (LUT). For example, the system control CPU 178 increases the number of times of signal charge transfer or shortens a time interval between transfer timings as the speed of the subject or the hand movement speed increases. Thereby, it is possible to obtain an optical flow with high accuracy when a moving image is captured. Here, the number of times of signal charge transfer in the above may be the number of times of exposure and the transfer timing may be an exposure timing.

In addition, the system control CPU (control device) 178 in FIG. 27 may determine whether to perform the optical flow estimation procedure shown in FIG. 35 based on a manipulation performed by a user (photographer), for example, an instruction for transition to a high-speed tracking mode or a hand movement correction and enhancement mode. That is, the system control CPU 178 includes an instruction determination device configured to determine whether a predetermined instruction has been received and when the instruction determination device determines that a predetermined instruction has been received, performs the optical flow estimation procedure shown in FIG. 35. Thereby, it is possible to obtain an optical flow with high accuracy when a moving image is captured.

In addition, the system control CPU (control device) 178 in FIG. 27 performs a sequence of exposure, transfer, and accumulation a plurality of times during one imaging period. Therefore, the system control CPU 178 controls a time interval and the number of signal charge transfers so that the time interval between transfer timings (may be exposure timings at which an exposure starts) at which signal charge transfer starts in one imaging period is half of one imaging period or shorter. For example, if one imaging period is 1/120 sec, the system control CPU 178 may set the number of signal charge transfers to 2 and set the time interval between transfer timings to 1/240 sec or shorter. Thereby, it is possible to obtain an optical flow with high accuracy when a moving image is captured

In the above imaging apparatus, functions performed by the system control CPU (control device) 178 in FIG. 27 may be implemented by hardware or software, or a combination thereof. A method of implementing such functions by hardware, software, or a combination thereof depends on an environment in which the above imaging apparatus is used or design constraints on the above imaging apparatus. If functions of the system control CPU 178 are implemented by software, a program that implements the functions may be provided to the above imaging apparatus from a host device via a network. In addition, the program may be provided to the above imaging apparatus from a storage medium (including a removable memory such as a memory card and a CD) in which the program is stored. In this case, the system control CPU 178 executes the program (software) that is acquired through a network or a recording medium and performs processes according to the present invention. Here, the system control CPU 178 can be replaced with a control device having functions equivalent thereto, for example, a microcomputer, a processor, and an application specific integrated circuit (ASIC).

### Other Embodiments

The present invention can be realized in processes in which a program that executes one or more functions of the above embodiment is supplied to a system or a device through a network or a storage medium, and one or more processors in a computer of the system or the device read and execute the program. In addition, the present invention can be realized by a circuit (for example, an ASIC) that implements one or more functions.

### CONCLUSION

While preferable examples of the first to third inventions have been described above, the first to third inventions are not limited to the above examples, and various modifications and alternations can be made within the scope of the spirit of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2017-140851 filed on Jul. 20, 2017, No. 2017-160110 filed on Aug. 23, 2017, and No. 2018-033447 filed on Feb. 27, 2018, which are hereby incorporated by reference herein in its entirety.

What is claimed is:

1. An imaging apparatus comprising:
a memory; and
a controller which operates on the basis of data stored in the memory,
wherein the controller comprises:
an imaging unit capable of continuously acquiring first images and second images for which a time from start of accumulation to end thereof is longer than that of the first image;
a computing unit configured to calculate a motion vector from the plurality of first images; and
an image processing unit configured to perform image processing on a moving image generated from the second images using the motion vector.

2. An imaging apparatus comprising:
a memory; and
a controller which operates on the basis of data stored in the memory,
wherein the controller comprises:
an imaging unit capable of continuously acquiring first images and second images for which a time from start of accumulation to end thereof is longer than that of the first image;
an optical unit configured to form an optical image of a subject on the imaging unit;
a computing unit configured to calculate a motion vector from the plurality of first images; and
an optical control unit configured to control the optical unit using the motion vector.

3. The imaging apparatus according to claim 1,
wherein, before the imaging unit ends reading of the second images, the imaging unit ends reading of the first images and the computing unit starts calculation of a motion vector.

4. The imaging apparatus according to claim 3,
wherein the computing unit additionally calculates a motion vector of the second images and reliabilities of respective motion vectors of the first images and the second images, and
if the calculated reliability of the motion vector of the first images is lower than the calculated reliability of the motion vector of the second images, the image processing unit or the optical control unit uses the motion vector of the second images.

5. An imaging apparatus comprising:
a memory; and
a controller which operates on the basis of data stored in the memory,
wherein the controller comprises:
an imaging unit capable of continuously acquiring first images and second images having a different accumulation time from the first images;
a first computing unit configured to calculate a motion vector from the plurality of first images;
a second computing unit configured to calculate a motion vector from the plurality of second images; and
a selection unit configured to select the motion vector calculated by the first computing unit and the motion vector calculated by the second computing unit,
wherein, if a time from when accumulation of the first images starts until accumulation ends is longer than a time from when accumulation of the second images starts until accumulation ends, the selection unit selects the motion vector calculated from the second image.

6. A control method of an imaging apparatus, the imaging apparatus comprising an imaging unit capable of continuously acquiring first images and second images for which a time from start of accumulation to end thereof is longer than that of the first images, the control method comprising:
a computing process in which a motion vector is calculated from the plurality of first images; and
an image processing process in which image processing is performed on a moving image generated from the second images using the motion vector.

7. A control method of an imaging apparatus, the imaging apparatus comprising an imaging unit capable of continuously acquiring first images and second images for which a time from start of accumulation to end thereof is longer than that of the first images and an optical unit configured to form an optical image of a subject on the imaging unit, the control method comprising:
a computing process in which a motion vector is calculated from the plurality of first images; and
an optical control process in which the optical unit is controlled using the motion vector.

8. A control method of an imaging apparatus, the imaging apparatus comprising an imaging unit capable of continuously acquiring first images and second images having a different accumulation time from the first images, the control method comprising:
a first computing process in which a motion vector is calculated from the plurality of first images;
a second computing process in which a motion vector is calculated from the plurality of second images; and
a selection process in which the motion vector calculated from the first image and the motion vector calculated from the second image are selected,
wherein, if a time from when accumulation of the first images starts until accumulation ends is longer than a time from when accumulation of the second images starts until accumulation ends, the motion vector calculated from the second images is selected in the selection process.

9. An imaging apparatus comprising:
a memory; and
a controller which operates on the basis of data stored in the memory,
wherein the controller comprises:
an imaging unit configured to repeatedly perform an exposure and a non-exposure a plurality of times in one imaging period and acquire first images and second images;
a detection unit configured to detect a speed of a subject on an image plane on the basis of the second images; and
a control unit configured to control an exposure in the imaging unit,
wherein the control unit controls an exposure for generating the first images according to the speed of the subject on the image plane.

10. The imaging apparatus according to claim 9,
wherein, regarding an exposure for acquiring the first images, the control unit sets a maximum non-exposure time in a range in which no non-exposure time appears in the first images according to the speed of the subject on the image plane and determines the number of exposures according to the non-exposure time.

11. The imaging apparatus according to claim 10,
wherein the control unit shortens the non-exposure time and increases the number of times of exposure if the speed of the subject on the image plane is high, and lengthens the non-exposure time and reduces the number of times of exposure if the speed of the subject on the image plane is low.

12. The imaging apparatus according to claim 10, further comprising:
a setting unit configured to receive setting of the number of ND stages by a photographer,
wherein the control unit controls an exposure for generating the first images according to the set number of ND stages and the speed of the subject on the image plane.

13. The imaging apparatus according to claim 12,
wherein the setting unit receives setting of whether the number of ND stages has priority, and
in the setting in which the number of ND stages has priority, the number of ND stages is not changed, and in the setting in which the number of ND stages has no priority, the control unit reduces the number of ND stages and shortens the non-exposure time if the speed of the subject on the image plane is higher than a predetermined speed.

14. The imaging apparatus according to claim 9,
wherein the imaging unit includes a plurality of pixel parts that are two-dimensionally arranged, and
the pixel parts include a photoelectric conversion unit and a plurality of signal holding units.

15. The imaging apparatus according to claim 14,
wherein, among the plurality of signal holding units, a first signal holding unit maintains a signal charge for generating the first images and a second signal holding unit maintains a signal charge for generating the second images.

16. The imaging apparatus according to claim 15,
wherein a signal charge accumulated in the first signal holding unit is acquired in a plurality of times of exposure during one imaging period and non-exposure times corresponding to the exposures are the same, and
a signal charge accumulated in the second signal holding unit is acquired in a plurality of times of exposure during one imaging period and non-exposure times corresponding to the exposures are different from each other.

17. The imaging apparatus according to claim 9,
wherein the first images are images for capturing and the second images are images for speed detection of the subject.

18. A control method comprising:
an imaging process in which an exposure and a non-exposure are repeated a plurality of times in one imaging period and first images and second images are acquired;
a detection process in which a speed of a subject on an image plane is detected on the basis of the second images; and
a control process in which an exposure in the imaging process is controlled,
wherein, in the control process, an exposure for generating the first images is controlled according to the speed of the subject on the image plane.

19. An imaging apparatus comprising:
an image element including a plurality of pixel parts, in which the pixel parts include a photoelectric conversion unit and a signal holding unit; and
a control unit configured to control the image element,
wherein the control unit includes
a first image signal generation unit configured to generate a first image signal based on a signal charge accumulated in the signal holding unit by n times of signal charge transfer (n is a natural number of 2 or higher) from the photoelectric conversion unit to the signal holding unit during a first imaging period,
a second image signal generation unit configured to generate a second image signal based on a signal charge accumulated in the signal holding unit by n times of signal charge transfer from the photoelectric conversion unit to the signal holding unit during a second imaging period,
a first averaging unit configured to generate a third image signal by averaging luminance values of the pixel parts with luminance values of a predetermined number of adjacent other pixel parts with respect to the generated first image signal,
a second averaging unit configured to generate a fourth image signal by averaging luminance values of the pixel parts with luminance values of a predetermined number of adjacent other pixel parts with respect to the generated second image signal,
an optical flow candidate calculation unit configured to calculate a plurality of optical flow candidates which are vectors indicating a movement direction and amount of a subject during the first and second imaging periods by comparing the first and second image signals,
an approximate optical flow calculation unit configured to calculate an approximate optical flow which is a vector indicating an approximate movement direction and amount of the subject during the first and second imaging periods by comparing the third and fourth image signals, and
an optical flow estimation unit configured to estimate one optical flow candidate that is closest to the approximate optical flow among the plurality of optical flow candidates as a final optical flow.

20. An imaging apparatus comprising:
an image element including a plurality of pixel parts, in which the pixel parts include a photoelectric conversion unit and a signal holding unit; and
a control unit configured to control the image element,
wherein the control unit includes
a first image signal generation unit configured to generate a first image signal based on a signal charge accumulated in the signal holding unit by n times of signal charge transfer (n is a natural number of 2 or higher) from the photoelectric conversion unit to the signal holding unit during a first imaging period,
a second image signal generation unit configured to generate a second image signal based on a signal charge accumulated in the signal holding unit by n times of signal charge transfer from the photoelectric conversion unit to the signal holding unit during a second imaging period, and
an optical flow estimation unit configured to estimate a final optical flow which is a vector indicating a movement direction and amount of a subject during the first and second imaging periods by comparing the first and second image signals,
wherein, in each of the first and second imaging periods, n times of the signal charge transfer are performed so that time intervals between n transfer timings at which transfer starts are different from each other.

21. The imaging apparatus according to claim 19,
wherein the control unit increases and decreases a value of n so that time intervals between n transfer timings at which n times of the signal charge transfer start are 1/120 sec or shorter in each of the first and second imaging periods.

22. The imaging apparatus according to claim 19,
wherein the control unit further includes a moving body determination unit configured to determine whether the subject is a moving body and, when the moving body determination unit determines that the subject is a moving body, estimates the final optical flow.

23. The imaging apparatus according to claim 19,
wherein the control unit further includes a speed determination unit configured to determine a speed of the subject or a hand movement speed, and when the speed determination unit determines that the speed of the subject or the hand movement speed is a predetermined value or greater, estimates the final optical flow.

24. The imaging apparatus according to claim 19,
wherein the control unit further includes an instruction determination unit configured to determine whether a predetermined instruction has been received, and when the instruction determination unit determines that the predetermined instruction has been received, estimates the final optical flow.

25. The imaging apparatus according to claim 19,
wherein the control unit controls a time interval and a value of n so that the time interval between n transfer timings at which n times of the signal charge transfer start in the first or second imaging period is at least half of the first or second imaging period or shorter.

26. The imaging apparatus according to claim 19,
wherein the control unit further includes a speed determination unit configured to determine a speed of the subject or a hand movement speed, and as the speed of the subject or the hand movement speed detected by the speed determination unit increases, increases a value of n and shortens the time interval between n transfer timings at which n times of the signal charge transfer start.

27. The imaging apparatus according to claim 19,
wherein the first image signal is generated when first exposure is performed n times during the first imaging period, and a signal charge generated by the photoelectric conversion unit according to the first exposures is transferred to the signal holding unit, and
the second image signal is generated when second exposure is performed n times during the second imaging period and a signal charge generated by the photoelectric conversion unit according to the second exposures is transferred to the signal holding unit.

28. The imaging apparatus according to claim 19,
wherein, in each of the first and second imaging periods, n times of the signal charge transfer are performed such that time intervals between n transfer timings at which transfer starts are equal to each other.

29. A control method of an imaging apparatus,
the imaging apparatus comprising:
an image element including a plurality of pixel parts, in which the pixel parts include a photoelectric conversion unit and a signal holding unit; and
a control unit configured to control the image element,
the control method comprising:
generating a first image signal based on a signal charge accumulated in the signal holding unit by n times of signal charge transfer (n is a natural number of 2 or higher) from the photoelectric conversion unit to the signal holding unit during a first imaging period,
generating a second image signal based on a signal charge accumulated in the signal holding unit by n times of signal charge transfer from the photoelectric conversion unit to the signal holding unit during a second imaging period,
generating a third image signal by averaging luminance values of the pixel parts with luminance values of a predetermined number of adjacent other pixel parts with respect to the generated first image signal,
generating a fourth image signal by averaging luminance values of the pixel parts with luminance values of a predetermined number of adjacent other pixel parts with respect to the generated second image signal,
calculating a plurality of optical flow candidates which are vectors indicating a movement direction and amount of a subject during the first and second imaging periods by comparing the first and second image signals,
calculating an approximate optical flow which is a vector indicating an approximate movement direction and amount of the subject during the first and second imaging periods by comparing the third and fourth image signals, and
estimating one optical flow candidate that is closest to the approximate optical flow among the plurality of optical flow candidates as a final optical flow.

30. A control method of an imaging apparatus,
the imaging apparatus comprising:
an image element including a plurality of pixel parts, in which the pixel parts include a photoelectric conversion unit and a signal holding unit; and
a control unit configured to control the image element,
the control method comprising:
generating a first image signal based on a signal charge accumulated in the signal holding unit by n times of signal charge transfer (n is a natural number of 2 or higher) from the photoelectric conversion unit to the signal holding unit during a first imaging period,
generating a second image signal based on a signal charge accumulated in the signal holding unit by n times of signal charge transfer from the photoelectric conversion unit to the signal holding unit during a second imaging period, and
estimating a final optical flow which is a vector indicating a movement direction and amount of a subject during the first and second imaging periods by comparing the first and second image signals,
wherein, in each of the first and second imaging periods, n times of the signal charge transfer are performed so that time intervals between n transfer timings at which transfer starts are different from each other.
